(19) United States
(12) Patent Application Publication
(10) Pub. No.: US 2026/0289511 A1
(43) Pub. Date: Sep. 24, 2026

(54) SYSTEM

(71) Applicant: SoftBank Group Corp., Tokyo (JP)

(72) Inventor: Keisuke SAKATA, Tokyo (JP)

(73) Assignee: SoftBank Group Corp., Tokyo (JP)

(21) Appl. No.: 19/567,423

(22) Filed: Mar. 16, 2026

(30) Foreign Application Priority Data
Mar. 19, 2025 (JP) 2025-044953

(51) Int. Cl. G06Q 10/1053; G06F 40/284; G06N 3/0475

(52) U.S. Cl. CPC G06Q 10/1053; G06F 40/284; G06N 3/0475

(57) ABSTRACT

A system includes a processor that is configured to: store, in a database, information regarding job contents and desired human resources, provide an interface through which a user inputs an instruction text to a generative AI model, and include a prompt generation module that analyzes the instruction text and generates a prompt text.

### CROSS-REFERENCE TO RELATED APPLICATION

This application is based on and claims priority under 35 USC 119 from Japanese Patent Application No. 2025-044953 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional personnel assignment and job matching systems typically rely on manually defined rules or simple keyword-based search functions. As a result, such systems cannot fully utilize complex and diverse information regarding job contents, desired human resources, qualifications, and experience values in combination with detailed user information such as experience values, achievements, requests, and personality. Furthermore, even when a generative AI model is available, there is no unified mechanism that enables a user to intuitively input an instruction and automatically transform that instruction into an appropriate prompt for the generative AI model, while at the same time performing systematic comparison and analysis between job information and user information. Consequently, it is difficult to provide accurate and explainable “right person for the right place” recommendations in situations such as job reassignment within an organization or job application by a user. Therefore, there is a need for a system that can store and manage job-related information, support user instruction input to a generative AI model, automatically generate prompts based on the instruction, and determine suitable personnel assignment by comparing and analyzing stored job information and user information, thereby enabling the generative AI model to provide effective right-person-right-place information.

### SUMMARY

To solve the above-described problems, a system is provided that comprises a processor configured to store, in a database, information regarding job contents and desired human resources, provide an interface through which a user inputs an instruction text to a generative AI model, and include a prompt generation module that analyzes the instruction text and generates a prompt text. The processor is further configured to compare and analyze recorded information including job contents, desired human resources, qualifications, and experience values with user information including experience values, achievements, requests, and personality, and determine a right person for a right place based on a result of the comparison and analysis. In addition, the processor is configured to generate the prompt so that a generative AI model provides right-person-right-place information usable when a user changes a job assignment or applies for a position, and execute the generative AI model by using the generated prompt. By integrating these functions, the system enables structured storage of job and user information, intuitive instruction input by the user, automatic prompt generation for the generative AI model, and highly accurate right-person-right-place determination and recommendation.

The term “processor” refers to any hardware component, hardware logic, central processing unit (CPU), microprocessor, microcontroller, programmable logic device, or combination thereof that is capable of executing instructions to perform the functions described in the claims.

The term “database” refers to any storage system or storage medium, including but not limited to relational databases, non-relational databases, file systems, or cloud-based storage services, that stores structured or unstructured data related to job contents, desired human resources, and user information.

The term “job contents” refers to information describing a job or position, including but not limited to job title, job description, responsibilities, required tasks, department, and other attributes associated with the job.

The term “desired human resources” refers to information describing attributes, capabilities, or profiles of persons who are suitable for performing a particular job, including but not limited to required traits, skills, competencies, qualifications, and experience values.

The term “interface” refers to any hardware or software component, such as a graphical user interface, command-line interface, web interface, application interface, or API endpoint, through which a user can input or output data, including an instruction text for a generative AI model.

The term “instruction text” refers to any natural language text, command, query, question, or other user-provided input that indicates a request, intention, or condition to be processed by the generative AI model.

The term “prompt generation module” refers to a software component, hardware component, or combination thereof that analyzes the instruction text and generates a corresponding prompt text suitable for input to a generative AI model.

The term “prompt text” refers to a text sequence, including but not limited to natural language sentences, structured text, or formatted data, provided as input to a generative AI model in order to cause the generative AI model to generate a desired output.

The term “generative AI model” refers to any artificial intelligence model or machine learning model capable of generating text, recommendations, or other content based on input data or prompts, including but not limited to large language models, transformer-based models, or similar generative models.

The term “user” refers to any person or entity that interacts with the system, including but not limited to employees, job applicants, human resources staff, administrators, or other operators who input instructions and review results.

The term “qualifications” refers to licenses, certifications, credentials, educational backgrounds, or other formal recognitions that indicate a person's eligibility or competency for a particular job or task.

The term “experience values” refers to data representing a person's past work experiences or activities, including but not limited to roles, projects, responsibilities, durations, and specific types of experience such as new business launch experience or management experience.

The term “achievements” refers to results or outcomes accomplished by a person, including but not limited to achieved sales targets, acquired new customers, awards, recognitions, or other measurable performance indicators.

The term “requests” refers to user preferences, intentions, or desired conditions related to future work or career, including but not limited to a desire for job reassignment, participation in new business, or gaining management experience.

The term “personality” refers to attributes or characteristics describing a person's behavioral tendencies or interpersonal style, including but not limited to communication ability, leadership, cooperativeness, and similar traits.

The term “right person for a right place” refers to a state or result in which a person whose attributes, qualifications, experience values, achievements, requests, and personality appropriately match the requirements and conditions of a particular job or position is identified or recommended.

The term “job reassignment” refers to an internal personnel action in which a user is moved from one job, role, or department to another within an organization based on organizational needs or personal preferences.

The term “job application” refers to an action in which a user expresses interest in or formally applies for a specific job or position, either within an organization or externally, using the system or related processes.

The term “right-person-right-place information” refers to information generated by the system or the generative AI model that indicates recommended job positions, explanations of suitability, or guidance for assignments or applications based on the matching between job information and user information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

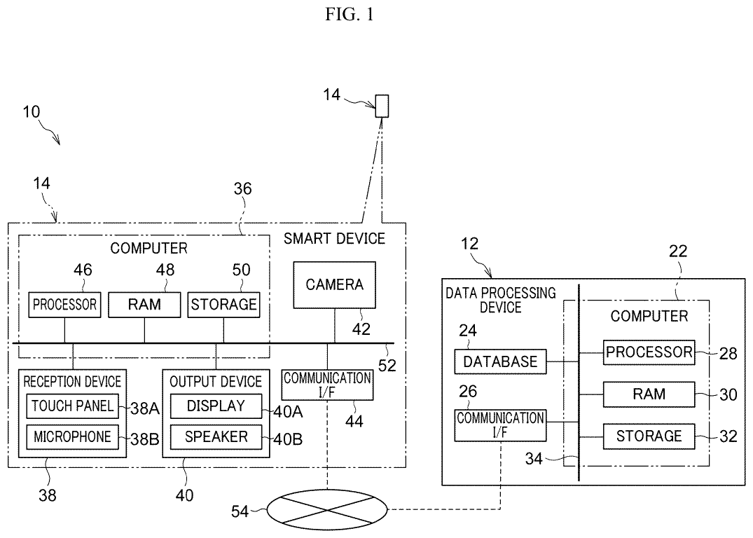

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

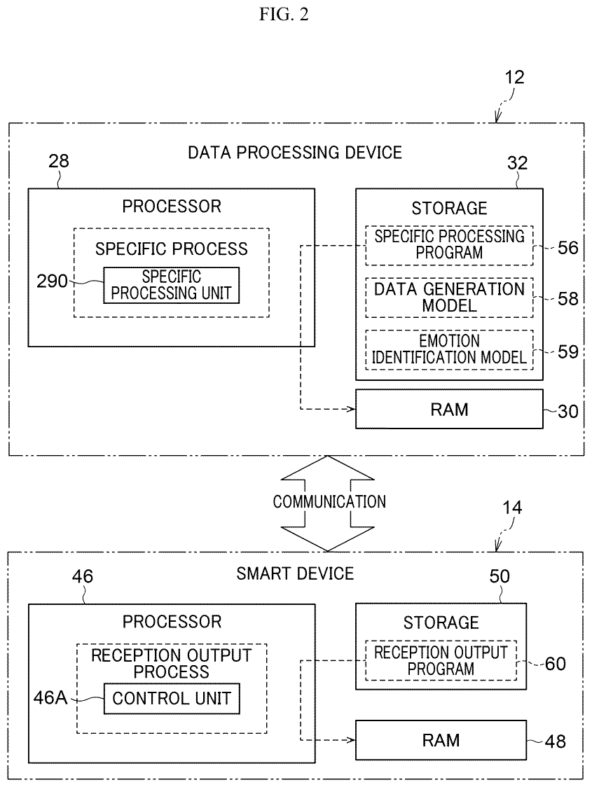

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional personnel management systems and job-candidate matching systems largely rely on rigid, predefined search forms and manually crafted filters defined by administrators or end users. In such systems, a user is typically required to translate a business requirement into a set of structured fields, such as fixed job codes, skill tags, qualification codes, and experience flags. This manual translation is often time-consuming and error-prone, and it forces users to conform to the schema and vocabulary of the underlying database and user interface rather than allowing them to express their actual needs in natural language. As a result, when business requirements evolve quickly, or when nuanced combinations of skills, qualifications, and experiences are needed, conventional systems frequently fail to retrieve suitable candidates or require multiple trial-and-error queries.

Furthermore, in many existing architectures, the use of machine learning or artificial intelligence models is limited to ranking or recommending candidates after a query has already been defined in structured form. In other words, the artificial intelligence is not used to bridge the gap between the user's natural-language intent and the underlying relational data model. Consequently, the burden of query formulation, including the selection of database fields and the construction of complex relational joins, remains on the user or on specialized technical staff. This leads to inefficiencies, reduced accessibility for non-technical users, and an increased likelihood of suboptimal personnel allocation.

In addition, many systems do not provide a robust, integrated mechanism for persistently storing heterogeneous personnel-related data—such as work classifications, skills, qualifications, and experiences—in a normalized relational structure that can be flexibly combined at query time. Even when such a relational database structure exists, there is often no standardized mechanism for automatically deriving appropriate query conditions and join operations from a user's free-form natural-language instruction. This limitation prevents effective utilization of detailed personnel data and hinders the ability to respond rapidly to changing organizational needs for personnel transfers, job assignments, and recruitment decisions.

From the standpoint of computer technology, these shortcomings manifest as an inefficient human-machine interface for query specification, suboptimal utilization of computing resources for search and retrieval, and a lack of automated translation between unstructured user input and structured query operations. Accordingly, there is a need for a technical solution that improves the functioning of the computer system itself by enabling the system to: (i) accept natural-language prompt sentences from users, (ii) automatically convert such prompt sentences into structured search conditions using a generative AI model, and (iii) efficiently execute relational database queries based on those search conditions to retrieve and present relevant personnel-related information. Such a solution would reduce the cognitive load on the user, improve the accuracy and relevance of search results, and enhance the overall efficiency of the data processing apparatus.

The specific processing by the specific processing unit 290 of the data processing device 12 in Example 1 is realized by the following means.

The present invention provides a server comprising a processor configured to receive, via an input/output interface, work-related information and human-resource-related information from a user, convert the received work-related information and human-resource-related information into structured information, transmit the structured information as a request based on a communication protocol, receive the structured information and store the structured information as relational information in a storage resource of an information management apparatus, input, into a generative AI model, a prompt sentence including a natural-language instruction received via the input/output interface, analyze the prompt sentence to obtain condition information, convert the condition information into search conditions, execute a search process on the relational information using a query language in accordance with the search conditions, and present a search result to the user via the input/output interface. This enables the computer system to automatically translate unstructured natural-language prompt sentences into optimized relational database queries, thereby improving the technical efficiency and accuracy of data storage, retrieval, and presentation for personnel allocation and related decision-making.

The term “processor” refers to a hardware or virtual computation unit, such as a central processing unit or a processing core, that executes machine-readable instructions to perform data processing operations.

The term “input/output interface” refers to a hardware and/or software interface, such as a graphical user interface, application programming interface, network interface, or combination thereof, through which data is received from and presented to a user or another system.

The term “work-related information” refers to information representing characteristics of work, including at least work classifications, job categories, or task types associated with business activities.

The term “human-resource-related information” refers to information representing attributes of personnel, including at least skills, qualifications, and experiences of individuals.

The term “structured information” refers to information represented in a predefined data format or schema, such as key-value pairs, tabular data, or hierarchical data, that is suitable for storage, retrieval, and processing by a computer system.

The term “communication protocol” refers to a set of rules and formats, including at least transport-level and application-level specifications, that govern the exchange of data between computing devices over a communication network.

The term “information management apparatus” refers to a computing system, including at least a processing unit and a storage resource, that is configured to store, manage, and provide access to data.

The term “storage resource” refers to a physical or virtual data storage component, such as a persistent memory device or logical storage volume, that is configured to store information for later retrieval and processing.

The term “relational information” refers to information stored in accordance with a relational data model, in which data is organized into related sets, such as tables or equivalent structures, that can be queried using a query language.

The term “generative AI model” refers to a machine-learned model, such as a neural-network-based language model, that is configured to generate or transform data, including at least generating or interpreting natural-language content, based on input data.

The term “prompt sentence” refers to a natural-language expression provided by a user, including at least an instruction or query, that is input to a generative AI model as a basis for generating or deriving output data.

The term “condition information” refers to information representing one or more constraints, requirements, or selection criteria that are derived from a prompt sentence or other input and that are used to define search conditions.

The term “search conditions” refers to a set of criteria specifying which data is to be retrieved from stored information, the criteria including at least attributes or values to be matched or compared during a search process.

The term “query language” refers to a formal language, such as a structured query language, that is used to specify operations for retrieving, inserting, updating, or deleting data stored in a data management system.

The term “search process” refers to a series of operations executed by a computer system to retrieve data from stored information based on search conditions specified using a query language or equivalent mechanism.

The term “work-classification information” refers to structured information that categorizes work into one or more classes, such as job roles, departments, or functional areas, for use in organizing and searching work-related information.

The term “skill information” refers to structured information representing abilities or competencies of personnel, which may include technical skills, interpersonal skills, or other capability indicators.

The term “qualification information” refers to structured information representing formal certifications, licenses, or other attestations that indicate that personnel satisfy predetermined professional or regulatory requirements.

The term “experience information” refers to structured information representing past activities, roles, or achievements of personnel, including at least prior job functions, project participation, or managerial responsibilities.

The term “join process” refers to a database operation, performed using a query language or equivalent mechanism, that combines data from multiple relational information sets based on one or more related attributes or keys.

The term “list format” refers to a presentation form in which multiple data items, such as candidate records, are displayed as an ordered or unordered collection, including at least rows in a table or entries in a list view.

The term “display control” refers to processing performed by a computer system to determine, generate, and update visual or other sensory representations of data on an output device in response to system state or user interaction.

The term “human-resource allocation candidate” refers to a personnel entity identified as a potential match for a particular work-related requirement, based on search conditions applied to human-resource-related information.

In one embodiment, a server, a terminal, and a user cooperate to implement the claimed system in a networked computer environment. The server includes at least one processor, a main memory, a non-volatile storage device such as a solid-state drive, and a network interface controlled by an operating system such as a general-purpose server operating system. The terminal includes a processor, a display, an input device such as a keyboard or touchscreen, a network interface, and a web browser or native client application. The user operates the terminal to access a web application or application interface provided by the server over a packet-based communication network such as the Internet or a local area network.

The server executes an application program implemented using, for example, an application framework such as a server-side web framework running on a runtime environment such as a virtual machine or an interpreter. The application program provides a user interface to the terminal in the form of markup content and script content, or in the form of a remote procedure call interface used by a native application. The terminal receives the user interface content, renders input fields and display components using the browser rendering engine or native UI toolkit, and enables the user to input work-related information and human-resource-related information.

The user inputs work-related information such as work classifications (“Sales,” “Development,” “Human Resources”) and human-resource-related information such as skills (“high communication skills,” “programming skills”), qualifications (“Real Estate Transaction Specialist,” “Information Technology Engineer”), and experiences (“new business launch experience,” “management experience”). The terminal captures these values via graphical input controls and converts them into structured information, for example key-value structures, using script logic executed by the processor of the terminal. The terminal encapsulates this structured information in a message formatted according to a communication protocol such as a hypertext transfer protocol over a secure transport protocol, and transmits the message to the server via the network interface.

The server receives the message at a network endpoint implemented by the server application. The server parses the message header and body and extracts the structured information representing work-related information and human-resource-related information. The server validates the structured information according to a predefined schema stored in memory, for example by checking data types, required fields, and value ranges. The server then maps the structured information to internal data structures and stores those structures as relational information in a data management component such as a relational database management system (for example, a database engine compatible with structured query language) running on the server or on an associated database server.

The server defines tables for work classifications, skills, qualifications, experiences, and personnel entities. For example, the server stores work-classification information in a work table with an identifier and a normalized description field, stores skill information in a skill table, stores qualification information in a qualification table, and stores experience information in an experience table. The server also maintains association tables that link personnel entities to corresponding work classifications, skills, qualifications, and experiences via foreign key relationships. By normalizing data into these relational tables, the server reduces redundancy and enables efficient join operations, which improves storage utilization and query performance.

The server uses indexing structures, such as B-tree indexes on frequently queried columns (for example, work classification identifiers, skill identifiers, qualification identifiers, and experience identifiers), to accelerate query execution. The server further stores additional metadata such as frequency statistics and cardinality information, which allow a query optimizer component of the database engine to select efficient execution plans. As a result, the system improves computational efficiency when executing complex queries that involve multiple joins and filter conditions.

The user subsequently inputs a natural-language prompt sentence intended to specify conditions for retrieving suitable personnel. The user enters the prompt sentence into a text input area displayed by the terminal. Examples of such prompt sentences include:

“Please find personnel for a sales position who have high communication skills, hold a Real Estate Transaction Specialist qualification, and have new business launch experience.”

“Please list candidates suitable for a development role who have strong programming skills, hold an Information Technology Engineer qualification, and have at least three years of management experience.”

“Search for personnel for a human resources position who have excellent interpersonal skills and experience designing evaluation systems, regardless of specific qualifications.”

“Find personnel who are fit for a leadership role in sales, with both project management experience and a Real Estate Transaction Specialist qualification.”

“Show all candidates who have launched at least two new businesses and have strong communication skills, even if they do not have formal qualifications.”

The terminal transmits the prompt sentence to the server using the same communication protocol. The server receives the prompt sentence and uses an integrated generative AI model to analyze the content of the prompt sentence and produce condition information that can be mapped onto the relational schema of the underlying database.

In one embodiment, the server employs a generative AI model implemented as a neural-network-based language model with a transformer architecture. The model includes a stack of self-attention layers, feed-forward layers, and embedding layers, and is parameterized by a large number of weight parameters. The server stores the model parameters in memory and loads them into an accelerator device such as a graphics processing unit or a tensor processing unit. The server tokenizes the prompt sentence into sub-word tokens using a predefined tokenizer, converts the tokens into vector representations using an embedding matrix, and feeds these vectors into the transformer layers.

The generative AI model processes the token embeddings using multi-head self-attention mechanisms that compute attention scores based on query, key, and value vectors. Each attention head computes weighted sums of value vectors according to similarity between queries and keys, enabling the model to capture long-range dependencies within the prompt sentence. The feed-forward layers apply non-linear transformations to the attention outputs. The model is trained in advance using supervised or semi-supervised learning, where training data pairs include natural-language descriptions of personnel requirements and corresponding structured representations of work classifications, skills, qualifications, and experiences. During training, the server minimizes a loss function such as a cross-entropy loss or a sequence-to-sequence loss measuring the difference between predicted structured outputs and ground-truth structured outputs. The server updates model weights by backpropagation and gradient-based optimization algorithms such as stochastic gradient descent or Adam. The server may employ regularization techniques such as dropout and weight decay, and may perform data augmentation by paraphrasing training sentences or injecting synonyms, thereby improving robustness. Because the model is trained off-line, the inference process in the deployed system uses fixed weights and does not update weights during normal operation, which ensures predictable behavior.

At runtime, the server uses the generative AI model in a constrained decoding mode. The server supplies the prompt sentence as input and instructs the model, via a system-level instruction or a control token sequence, to output a structured representation conforming to a predefined schema (for example, work_classification, required_skills, required_qualifications, required_experiences, and optional numeric constraints such as years_of_experience). The server constrains the output vocabulary for certain fields to match known values stored in the relational tables, or uses a post-processing module that maps free-form textual outputs to canonical entries by comparing token sequences with dictionary entries using string similarity metrics. In this manner, the server ensures that the condition information produced by the model can be reliably translated into search conditions that correspond to actual database fields and values.

The server converts the condition information obtained from the generative AI model into search conditions expressed in an internal intermediate representation. For example, the server creates a set of predicates such as (work_classification=“Sales”), (skill includes “high communication skills”), (qualification includes “Real Estate Transaction Specialist”), and (experience includes “new business launch experience”). The server then compiles these predicates into a query expressed in a query language such as structured query language. The server explicitly represents join relationships between the personnel table and the work, skill, qualification, and experience tables. By using an intermediate predicate representation and a query generator, the server can systematically construct complex queries that a human user would have difficulty formulating manually.

The server benefits from the generative AI model by automatically inferring relevant database fields and filter conditions from the natural-language prompt sentence, which improves query formulation accuracy and reduces user error. This is not a mere automation of human mental steps; rather, the system applies model-based mapping and schema-aware normalization that cannot be feasibly duplicated by a human in real time for large, high-dimensional schemas. The server executes the generated query on the relational information stored in the database. Due to the previously described indexing and normalization, the query engine performs optimized join operations, filter operations, and sorting operations. The server receives the query result as a set of rows corresponding to personnel entities that satisfy the search conditions. The server may further apply a ranking algorithm, implemented as deterministic computation, to sort candidates based on composite scores that consider multiple attributes (for example, number of matching skills, presence of required qualifications, and recency of experience). The server then formats the selected information into a response structure and transmits the response to the terminal.

The terminal receives the response and renders the human-resource-related information in a list format on the display device. The terminal presents each candidate with associated work classifications, skills, qualifications, and experiences. The user can select one or more candidates as human-resource allocation candidates by interacting with selection controls displayed by the terminal. The terminal may also support drill-down views that display more detailed metadata for each candidate. Because the server already precomputes and structures the search results, the terminal can render complex views with minimal additional processing, thus reducing processing load on the terminal and improving user experience.

The described configuration yields specific technical effects. By using a generative AI model with a transformer architecture to convert natural-language prompt sentences into structured condition information that directly maps to relational database fields and join relationships, the server improves the efficiency and accuracy of query formulation. The system reduces the need for multiple trial-and-error database queries created manually by the user, decreasing the overall number of queries executed and reducing network and database load. The normalization and indexing of relational information, combined with machine-generated query structures, reduce average query execution time and improve scalability when processing large volumes of personnel data.

The system also reduces errors in interpreting natural-language requirements, since the generative AI model is trained on a large dataset of requirement descriptions and corresponding structured representations, enabling it to capture domain-specific patterns and terminology that simple keyword search or rule-based parsing cannot handle. The mapping to canonical work classifications, skills, qualifications, and experiences further minimizes ambiguity. This contributes to lower false positive and false negative retrieval rates, improving the precision and recall of the search process.

In contrast to conventional rule-based systems, the server does not rely on a fixed set of hand-crafted parsing rules that are difficult to maintain. Instead, the server uses learned parameters of the generative AI model to dynamically interpret diverse natural-language inputs. The server can also support multiple languages by training the model on multilingual data, enabling cross-lingual query interpretation without altering the underlying database schema. This flexibility is a technical improvement in the way the computer processes and interprets text input and transforms it into structured queries.

The system further improves computer resource utilization by separating the responsibilities of the generative AI model and the relational database engine. The generative AI model focuses on semantic interpretation and condition extraction, while the relational database engine focuses on executing optimized queries using indices and join algorithms. This division of labor prevents the generative AI model from being used as a general-purpose search engine over raw data, which would be computationally inefficient, and instead deploys the model only where its capabilities are required.

In alternative embodiments, the server employs different neural network architectures such as encoder-decoder models or recurrent neural networks with attention, provided that the model outputs structured condition information from the prompt sentence. The server may store the generative AI model and its parameters on separate compute nodes and access the model via a remote procedure call protocol, or integrate a hardware accelerator directly in the same physical server. The server may also update the generative AI model periodically using newly accumulated prompt sentences and corresponding search results, allowing adaptive improvement of accuracy while preserving compatibility with existing database structures. In another embodiment, the server employs an ensemble of models that include both a generative AI model and a rule-based parser. The server compares outputs from each component and resolves conflicts using a scoring function that considers model confidence scores, lexical similarity to known database values, and historical success rates. This hybrid approach enables robust interpretation of prompt sentences that include rare or ambiguous expressions, while maintaining deterministic fallback behavior when the generative AI model output is inconsistent.

In still another embodiment, the server includes a caching mechanism that stores frequently used search conditions and associated query plans. When the user inputs a prompt sentence similar to a previously processed sentence, the server detects similarity using vector embeddings generated by the generative AI model and retrieves a cached query plan instead of constructing a new query. This reduces computation time for query generation and leverages prior model outputs, providing an additional technical improvement in processing efficiency.

Through these configurations and variations, the server, the terminal, and the user cooperate to implement a system in which natural-language prompt sentences are transformed into structured search conditions via a generative AI model and then applied to relational information stored in a database with optimized data structures. The system thereby improves the operation of the computer itself by enhancing query formulation, decreasing processing time, reducing data access errors, and enabling more effective use of storage and computational resources, rather than merely automating a human mental process or business workflow.

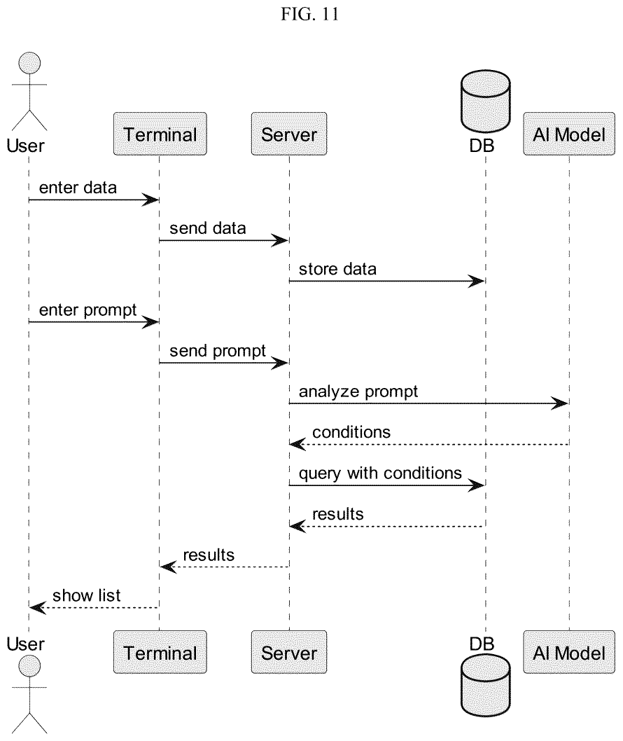

The following describes the processing flow using FIG. 11.

Step 1:

The user operates the terminal to input work-related information and human-resource-related information.

The user enters, as input, textual values such as work classifications (for example, “Sales,” “Development,” “Human Resources”), skills (for example, “high communication skills,” “programming skills”), qualifications (for example, “Real Estate Transaction Specialist,” “Information Technology Engineer”), and experiences (for example, “new business launch experience,” “management experience”) into input fields displayed on the terminal. The terminal receives these user inputs and performs basic validation, such as checking that required fields are not empty and that text lengths fall within predefined limits. As an output, the terminal produces an internal representation of the input values, for example a set of key-value pairs stored in the terminal's working memory.

Step 2:

The terminal converts the validated input values into structured information suitable for transmission to the server.

The terminal takes, as input, the key-value pairs created in Step 1 and executes client-side logic to transform them into a structured data object compliant with a predefined schema (for example, fields such as “work_classification,” “skills,” “qualifications,” and “experiences”). The terminal then serializes this structured data object into a text-based format such as a structured message body for an HTTP request.

The terminal sets communication protocol headers (for example, content type and authentication information) and encapsulates the serialized data as the payload of a request message. As an output, the terminal generates a complete request message ready to be sent over the network.

Step 3:

The terminal transmits the structured information to the server via a communication network. The terminal takes, as input, the prepared request message from Step 2 and uses a network interface to establish or reuse a communication channel based on a protocol such as HTTPS over TCP/IP. The terminal performs protocol-specific operations, including opening a socket, performing any necessary handshake, and sending the request bytes to the server's network address.

The terminal does not alter the structured data during this step; instead, the main “data processing” is packaging and routing of the bytes across the network. As an output, the terminal causes the server to receive the same structured information at a designated endpoint.

Step 4:

The server receives the structured information and parses it into internal data structures. The server takes, as input, the request message delivered via the network in Step 3. The server's communication stack decodes the transport- and application-layer headers and passes the message body to the application logic. The server parses the serialized text into an internal structured representation according to the predefined schema.

During this parsing, the server performs data-type conversions (for example, converting string arrays into array objects) and verifies that mandatory fields such as work-related information and human-resource-related information are present. As an output, the server produces validated internal objects representing work classifications, skills, qualifications, and experiences for subsequent storage.

Step 5:

The server stores the work-related information and human-resource-related information as relational information in a data management component.

The server takes, as input, the internal objects generated in Step 4. The server maps these objects to database entities according to a relational schema that includes tables for work classifications, skills, qualifications, experiences, and personnel entities, as well as association tables linking them. The server generates structured queries (for example, INSERT or UPDATE statements) and sends them to the relational database engine.

The database engine applies normalization logic, assigns primary keys, maintains indexes, and persists the data to non-volatile storage. The server may also check for existing identical records and reuse identifiers to avoid duplication. As an output, the server produces persistent relational records and updated index entries that can be later retrieved and joined efficiently.

Step 6:

The user inputs a prompt sentence that expresses search conditions in natural language. The user uses the terminal interface to type a prompt sentence into a text field and confirm the input. Example prompt sentences include:

“Please find personnel for a sales position who have high communication skills, hold a Real Estate Transaction Specialist qualification, and have new business launch experience.”

“Please list candidates suitable for a development role who have strong programming skills, hold an Information Technology Engineer qualification, and have at least three years of management experience.”

The terminal receives the prompt sentence as input, performs basic checks such as non-emptiness and maximum length, and stores it in the terminal's memory. As an output, the terminal provides a clean text string ready for transmission to the server.

Step 7:

The terminal transmits the prompt sentence to the server for interpretation.

The terminal takes, as input, the prompt sentence from Step 6 and encapsulates it in a structured message with a field such as “prompt_sentence.” The terminal serializes this message and sends it to a dedicated server endpoint for prompt processing via the same communication protocol as in Step 3.

The terminal's data processing in this step consists of serialization and protocol framing, without modifying the semantic content of the prompt sentence. As an output, the terminal causes the server to receive the textual prompt sentence in a machine-readable structured format.

Step 8:

The server preprocesses the prompt sentence and prepares it for input to the generative AI model.

The server takes, as input, the structured message containing the prompt sentence received in Step 7. The server extracts the prompt text and normalizes it by applying operations such as trimming whitespace, converting to a canonical character encoding, and optionally lowercasing or normalizing punctuation, depending on the tokenizer requirements.

The server then tokenizes the normalized text into sub-word or word tokens using a predefined tokenizer associated with the generative AI model. The server converts each token into an integer identifier and then into an embedding vector using an embedding table stored with the model parameters. As an output, the server produces a sequence of numerical vectors that represent the prompt sentence in a form suitable for processing by the generative AI model.

Step 9:

The server applies the generative AI model to derive condition information from the prompt sentence.

The server takes, as input, the sequence of embedding vectors generated in Step 8. The server feeds these vectors into a generative AI model implemented as a multi-layer neural network, for example a transformer-based language model comprising stacked self-attention layers and feed-forward layers. Each layer performs matrix multiplications, non-linear activations, and attention-weight computations to propagate context information across tokens.

The server constrains the model's decoding process to output a structured representation of the prompt, for example fields such as “work_classification,” “required_skills,” “required_qualifications,” “required_experiences,” and optional numeric constraints. The server may use special control tokens or decoding templates to enforce this structure. The model outputs probability distributions over possible tokens at each position; the server selects tokens according to a deterministic decoding strategy (for example, greedy decoding or beam search with rules limiting the vocabulary to known schema elements).

The server then converts the selected tokens back into text and parses that text into machine-readable condition information, such as lists of canonical work classifications, skills, qualifications, and experiences. As an output, the server produces structured condition information that reflects the semantic intent of the prompt sentence.

Step 10:

The server maps the condition information to search conditions aligned with the relational schema.

The server takes, as input, the condition information produced in Step 9. The server consults reference tables or dictionaries that map textual labels to database identifiers, and performs operations such as exact matching, case-insensitive comparison, or approximate string matching to align the condition information with actual stored values.

The server creates a set of logical predicates, for example: (work_classification_id=specific_id), (skill_id in set_of_ids), (qualification_id in set_of_ids), and (experience_id in set_of_ids). The server may also encode numeric constraints (for example, minimum years of experience) as comparison predicates. As an output, the server constructs a structured set of search conditions that explicitly describe which database fields and values must be matched.

Step 11:

The server generates and executes a database query based on the search conditions. The server takes, as input, the set of search conditions generated in Step 10. The server uses a query builder or template engine to translate the predicates into a query language statement, such as a SELECT statement with JOIN clauses linking the personnel table with the work, skill, qualification, and experience tables. The server applies WHERE clauses corresponding to the search conditions and may include ORDER BY clauses to sort candidates by relevance. The server submits this query to the relational database engine. The database engine uses indices and an execution planner to choose optimized access paths and join algorithms (for example, nested-loop join, hash join, or merge join). As an output, the server receives a result set consisting of rows that represent personnel entities satisfying the specified conditions.

Step 12:

The server post-processes the query result and prepares a response for the terminal. The server takes, as input, the result set returned by the database engine in Step 11. The server converts each row into an application-level record structure, resolving foreign keys into human-readable attributes such as work names, skill names, qualification descriptions, and experience descriptions. The server may compute additional metrics, such as a match score that aggregates the number and importance of satisfied conditions.

The server then organizes the records into a list format suitable for display and serializes this list into a response message structured according to a predefined output schema. As an output, the server generates a response message that encapsulates the human-resource-related information for the matching personnel.

Step 13:

The terminal receives and displays the list of candidate personnel to the user.

The terminal takes, as input, the response message sent by the server in Step 12. The terminal parses the structured content into internal data structures and populates a list or table component in the user interface. The terminal arranges each candidate as a row or entry showing attributes such as work classification, skills, qualifications, and experiences, and may highlight fields that match the conditions derived from the prompt sentence.

The terminal then renders the updated user interface on the display. As an output, the terminal presents a visually organized list of candidate personnel, enabling the user to perceive the results and to perform subsequent selections or actions based on the displayed information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional techniques for assigning personnel to tasks in an industrial environment typically rely on static rule sets, manual decision-making by supervisors, or batch optimization processes that do not react promptly to real-time changes on the work site. In many existing systems, task information and personnel information are stored in separate data silos and are not continuously synchronized with real-time status data such as current location, availability, or on-site conditions. As a result, even if large amounts of personnel data are collected, the assignment logic remains largely heuristic, slow to update, and difficult to scale.

Furthermore, known computer-implemented assignment systems often utilize either a deterministic matching algorithm or a machine learning model, but they do not effectively combine structured numerical scoring with natural-language reasoning to generate assignment proposals that are both optimized and understandable to human operators. In particular, existing systems typically lack a mechanism to transform internal numerical suitability scores into context-rich natural-language explanations and recommendations by using a generative AI model driven by carefully constructed prompt sentences. This makes it difficult for supervisors and users to understand the rationale behind the recommendations, to provide meaningful feedback, and to iteratively improve the assignment engine.

In addition, feedback from users regarding acceptance or modification of proposed assignments is rarely integrated back into the computational pipeline in a systematic way. Existing systems do not provide a technical framework in which human feedback is recorded as structured data and is then used to update parameters of the underlying machine learning models and prompt generation logic. As a consequence, the system cannot learn from real-world decisions and remains brittle in the face of changing factory conditions, evolving skill sets, and organizational policies.

Moreover, prior systems do not provide a cohesive computer architecture that unifies: (i) continuous ingestion and updating of task data and personnel data in a shared memory space; (ii) real-time integration of data from on-site information acquisition devices; (iii) transformation of such data into feature vectors for numerical computation; (iv) ranking and selection of candidate personnel; and (v) generation of natural-language prompts and responses via a generative AI model. Without such an integrated architecture, it is difficult to maintain consistent data semantics across different components, to guarantee timely updates of assignment proposals, and to implement closed-loop optimization that couples machine inference with human feedback.

Accordingly, there is a need for an improved computer-implemented system that technically enhances the process of personnel assignment by: (1) unifying real-time task and personnel data in a single computational framework, (2) leveraging a machine learning model to compute numerical suitability values, (3) automatically generating prompt sentences including these values as context for a generative AI model, and (4) feeding user feedback back into the models and prompt generation procedure. Such a system should improve the functioning of the computer itself by enabling more efficient data processing, more accurate and adaptive assignment computations, and more intelligible outputs for human operators, thereby reducing manual workload and error-prone ad hoc decision-making.

The specific processing by the specific processing unit 290 of the data processing device 12 in Application Example 1 is realized by the following means.

The present invention provides a server comprising a processor and a memory, the processor being configured to store task information and personnel information as data structures in the memory, receive real-time personnel information including identification information, location information, and activity status information from an information acquisition device installed at a work site, update the personnel information stored in the memory based on the real-time personnel information, convert the task information and the personnel information into feature vectors, calculate numerical suitability values between tasks and personnel by using a machine learning model executed by the processor, select candidate personnel for each task on the basis of the numerical suitability values, generate a prompt sentence for a generative AI model by constructing context information including attribute information of the candidate personnel and the numerical suitability values, transmit the prompt sentence to an external generative AI model via a communication interface, receive assignment proposal information generated by the generative AI model, generate structured data representing the assignment proposal information, provide the structured data to a terminal device or a display device as candidate personnel assignments and corresponding explanatory information, receive approval information or modification information for the candidate personnel assignments from a user via the terminal device, store a result of the approval information or the modification information in the memory as feedback data, and update at least one of parameters of the machine learning model and parameters of prompt sentence generation processing on the basis of the feedback data. This enables the computer system to implement a closed-loop, real-time optimization workflow in which task and personnel data are continuously synchronized, numerical suitability computation and candidate selection are performed efficiently within the processor, generative AI is invoked with context-aware prompt sentences to produce human-interpretable assignment proposals, and user feedback is incorporated as structured training signal, thereby improving the technical performance, adaptability, and explainability of the personnel assignment processing executed by the server.

The term “processor” refers to an electronic data processing unit, such as a central processing unit or a graphics processing unit, that executes instructions to perform arithmetic, logical, input/output, and control operations.

The term “memory” refers to a non-transitory computer-readable storage medium, such as a semiconductor memory or a magnetic storage device, that stores instructions and data for access by the processor.

The term “task information” refers to data representing work requirements, including at least a description of work to be performed, required skills, required qualifications, required experience, and optionally shift conditions or location conditions.

The term “personnel information” refers to data representing attributes of workers, including at least identification information, skills, qualifications, experience, preferences, and optionally personality-related attributes.

The term “real-time personnel information” refers to personnel-related data that is obtained or updated at short time intervals during operation, including at least current identification, current location, and current activity status of personnel.

The term “identification information” refers to data that uniquely or nearly uniquely identifies a person, such as an identifier code, a badge ID, or a token associated with a worker. The term “location information” refers to data indicating a physical position of personnel within a facility or work site, such as a line identifier, a station identifier, or coordinates within a defined area.

The term “activity status information” refers to data representing the current operational state of personnel, including at least availability, busy status, break status, or assignment status. The term “information acquisition device” refers to hardware equipment configured to detect or read data related to personnel, such as a code reader, a tag reader, or a sensor device installed at a work site.

The term “work site” refers to a physical environment in which tasks are carried out by personnel, such as a production area, a line, a station, or another operational area. The term “feature vector” refers to a numerical representation of a set of attributes of tasks or personnel, generated by encoding categorical and numerical attributes into a fixed-dimensional numeric array suitable for input into a machine learning model.

The term “machine learning model” refers to a computational model, such as a neural network or another statistical model, that has been trained on data to compute outputs, including numerical suitability values, from input feature vectors. The term “numerical suitability value” refers to a numeric score, probability, or rating that quantifies the degree of match or compatibility between a task and personnel as computed by the machine learning model.

The term “candidate personnel” refers to one or more workers selected as potential assignees for a particular task based on at least the numerical suitability values and optional constraints. The term “attribute information” refers to data describing characteristics of tasks or personnel, including at least skills, qualifications, experience, preferences, and status-related information.

The term “context information” refers to combined data that includes attribute information and numerical suitability values, organized for use as input to a generative AI model. The term “prompt sentence” refers to a natural-language or text-based instruction composed from context information and provided as input to a generative AI model to cause the generative AI model to produce an output.

The term “generative AI model” refers to an artificial intelligence model, such as a large language model, that is configured to generate text or other data outputs based on an input prompt.

The term “external generative AI model” refers to a generative AI model that is executed on a computing resource separate from the server, and that is accessed by the server through a communication interface.

The term “communication interface” refers to a hardware and software communication facility, such as a network interface and associated protocols, that enables data exchange between the server and an external device or service.

The term “assignment proposal information” refers to data generated by the generative AI model that specifies one or more recommended personnel for one or more tasks and includes textual or structured reasons for such recommendations.

The term “structured data” refers to data arranged according to a predefined format or schema, such as a record, a table, or a structured message, enabling programmatic parsing and processing.

The term “terminal device” refers to an end-user computing device, such as a mobile device, a tablet, a personal computer, or a dedicated terminal, configured to communicate with the server and present information to a user.

The term “display device” refers to hardware configured to visually present information, including at least monitors, panels, or displays integrated into terminal devices or fixed equipment. The term “candidate personnel assignment” refers to a proposed mapping between a task and one or more personnel, identified as a potential assignment before final approval or modification by a user. The term “explanatory information” refers to data, usually in natural-language form, describing reasons or justification for a particular candidate personnel assignment. The term “user” refers to a human operator, such as a supervisor, manager, or worker, who interacts with the system to review, approve, or modify candidate personnel assignments. The term “approval information” refers to data input by a user indicating acceptance or confirmation of a candidate personnel assignment proposed by the system. The term “modification information” refers to data input by a user indicating a change to a candidate personnel assignment, such as substitution of personnel or adjustment of task allocation. The term “feedback data” refers to stored data representing user responses, including approval information and modification information, that is used to adjust operation of the machine learning model or prompt generation logic. The term “prompt sentence generation processing” refers to a series of computational operations that assemble context information into a prompt sentence for input to a generative AI model.

In one embodiment, a server executes a personnel assignment system using a processor and a memory interconnected via a system bus. The server uses common hardware such as a multi-core central processing unit, a graphics processing unit for acceleration of numerical computation, a volatile main memory, a non-volatile storage device, and a network interface controller. The server runs an operating system such as a general-purpose server operating system, and executes application software implemented, for example, in a high-level programming language such as Python. The server accesses a relational database management system, such as an embedded relational database, to store task information, personnel information, and feedback data in relational tables.

The server stores, in the memory, executable modules including a data ingestion module, a feature generation module, a machine learning inference module, a prompt generation module, a generative AI interaction module, a result structuring module, and a feedback integration module. The server further stores configuration data including a predefined list of skills, qualifications, and task categories, and a trained machine learning model for numerical suitability computation. The machine learning model is implemented, for example, using a neural network framework such as a tensor-based deep learning library.

The server stores task information and personnel information as structured records in the database. The server defines a table for tasks that includes at least: a task identifier field, a natural-language description field, a set of required skills fields encoded as a list or bit mask, a set of required qualifications fields, a required experience field expressed in years or levels, and optional fields such as shift category, line identifier, or location constraints. The server defines a table for personnel that includes a personnel identifier field, name or alias fields, a set of skills fields, a set of qualifications fields, an experience field, preference fields encoding desired shifts or work areas, and optional personality attribute fields. The server uses a fixed schema and encodes multi-valued attributes as serialized arrays or separate normalized tables to ensure efficient retrieval and update.

The server receives real-time personnel information from an information acquisition device installed at a work site. The information acquisition device is implemented, for example, as a scanner that reads optical codes or proximity tags attached to worker equipment, such as helmets or badges. The device may also include localization sensors such as wireless signal receivers. The terminal operates as an intermediary between the information acquisition device and the server. The terminal runs a client application on a mobile computing unit, such as a handheld device or a tablet, and communicates with the scanner or tag reader using wired or wireless communication. The terminal converts raw readings into a structured representation that includes at least a personnel identifier, current location, and current activity status, and transmits this representation to the server via a network protocol such as HTTPS.

The server updates a real-time personnel status table in the database and, in some embodiments, in an in-memory cache. The server writes or updates records containing personnel identifiers, location indicators, current task identifiers if known, availability flags, and timestamps. The server maintains indexes on the personnel identifier and location fields to enable low-latency queries. By integrating these real-time updates with static personnel attributes, the server maintains a coherent view of the current deployment state. This integration allows the server to reduce the need for repeated full-table scans and to limit recalculation of suitability values to personnel whose status has changed, thereby improving computational efficiency.

The server converts task information and personnel information into feature vectors for machine learning inference. The server uses a feature generation module that applies deterministic encoding operations. For categorical attributes such as skills and qualifications, the server maps each possible value to an index in a fixed-length vector and sets corresponding elements to binary or multi-valued weights. For numerical attributes such as experience years, the server applies normalization, for example subtracting a mean value and dividing by a standard deviation pre-computed from historical data. For preference attributes, the server encodes matches and mismatches with task constraints as separate numeric dimensions. The server concatenates encoded task and personnel vectors into a composite feature vector representing a task-personnel pair.

The server executes a machine learning model that is trained to output a numerical suitability value for each task-personnel feature vector. In one embodiment, the server uses a feed-forward neural network that includes an input layer corresponding to the feature vector dimension, one or more hidden layers with non-linear activation functions such as rectified linear units, and an output layer producing a scalar suitability score in a range, for example, between 0 and 1. The server stores network weights and biases as arrays in the memory and executes forward propagation computations using a numerical library optimized for vector and matrix operations. The server uses batched inference to process multiple task-personnel pairs simultaneously, thereby improving throughput.

In one training embodiment, the server or an offline training system trains the neural network using supervised learning. The training data include historical task-personnel assignments labeled as successful or unsuccessful, or including graded evaluations. The training system defines a loss function such as mean squared error or cross-entropy between predicted suitability and ground truth labels. The training system performs backpropagation to compute gradients of the loss with respect to network weights and updates the weights using an optimization algorithm such as stochastic gradient descent or a variant thereof. The server then deploys the trained model for inference. By using learned weights instead of fixed rules, the server improves prediction accuracy and adapts to complex patterns in the data that are not easily captured by manually defined heuristics.

The server selects candidate personnel for each task using the numerical suitability values output by the neural network. The server first filters personnel based on hard constraints such as required qualifications and real-time availability flags in the status table. The server then sorts remaining candidates by their suitability scores and selects a predetermined number of top candidates or those whose scores exceed a threshold. The server also applies conflict resolution rules to avoid assigning the same person to incompatible tasks or to avoid exceeding capacity constraints such as maximum workload per person. These rules are implemented as algorithmic checks in the processor, not as purely conceptual business rules, and are used to determine which feature vectors are passed to subsequent processing. The server generates a prompt sentence for a generative AI model by constructing context information from the selected candidates and tasks. The server assembles a textual representation that includes, for each task, a description of required skills, qualifications, and experience, and for each candidate personnel, a summary of skills, qualifications, experience, preferences, and current status. The server embeds numerical suitability values explicitly in the prompt sentence, for example by stating that a particular candidate has a suitability score of 0.92 for a given task. The server combines this information into a coherent block of natural language and appends explicit instructions on desired output format and level of detail. By including machine-generated numerical scores and explicit context in the prompt, the server shapes the behavior of the generative AI model in a way that is not achievable by human free-form input alone.

For example, the server generates a prompt sentence such as:

“Factory worker assignment task:

We have the following job and workers.

Job:
Job ID J210: ‘New product line assembly’.
Required skills: soldering, inspection.
Required certifications: electrical work certification.
Minimum experience: 3 years.

Candidate workers:
W102: skills: soldering, line inspection; certifications: electrical work certification; experience: 5 years; preferences: day shift, assembly; personality: careful, team oriented; current status: available at Line A.
W205: skills: packaging; certifications: none related to electrical work; experience: 1 year; preferences: night shift; personality: fast, less detail-oriented; current status: available at Line C.

Our neural network model produced the following suitability scores (0 to 1):
W102 for J210: 0.92
W205 for J210: 0.45

Using this information, act as an assignment planner.
1. Select the most suitable worker or workers for Job J210.
2. Explain the reasons clearly but concisely in 2-3 sentences.
3. Output your answer in a structured textual form with fields: job_id, recommended_worker_ids, and explanation.”

The server transmits the prompt sentence via a communication interface to an external generative AI model, which may be implemented on a remote computing resource. The server uses a defined application programming interface over a network link and includes the prompt sentence in a request message. The external generative AI model is, for example, a large language model with a transformer architecture trained on textual data. The server does not treat the model as a black box; instead, the server deliberately controls input format, context density, and instruction structure to improve reproducibility and reduce ambiguity of the output.

The server receives assignment proposal information from the external generative AI model and converts it into structured data. The assignment proposal information includes at least, for each task, a recommended worker identifier or a set of recommended worker identifiers, and an explanation of the reasons for selection expressed in natural language. The server parses the generated text to extract fields based on delimiters or key phrases indicated in the instructions. The server then creates records in an assignment table, storing task identifiers, recommended personnel identifiers, suitability scores obtained from the neural network, and the textual explanations.

The terminal presents the structured assignment proposal information to a user. The terminal displays, on a graphical user interface, a list of tasks and corresponding recommended personnel, along with explanations derived from the generative AI model. The terminal uses interface components such as buttons or selection controls to allow the user to approve or modify assignments. The terminal transmits user actions back to the server in the form of structured messages indicating approval or modification decisions.

The user interacts with the terminal to review, approve, or adjust candidate personnel assignments. The user may accept suggested assignments that the user deems appropriate, or the user may select alternative personnel from a list. The user may also enter comments describing reasons for modification, such as temporary health constraints or special project priorities. These user interactions form feedback data that the server uses to update internal models and configurations.

The server stores the feedback data in a feedback table that relates tasks, personnel, the proposed assignment, the user decision, and optional comments. The server periodically analyzes the feedback data to adjust parameters of the machine learning model and the prompt generation logic. In one embodiment, the server computes statistics such as the acceptance rate as a function of suitability score and recalibrates acceptance thresholds or score normalization accordingly. In another embodiment, the server uses feedback as additional training labels to fine-tune the neural network; the server modifies the loss function to penalize predictions that conflict with accepted assignments and retrains model weights using incremental learning methods. The server also adjusts prompt templates, for example by emphasizing certain attributes that are consistently cited in accepted explanations, thereby reducing the need for manual correction.

The described architecture improves computer technology beyond mere automation of human judgment. By using a specific data structure design and a combined pipeline of numerical inference and generative language processing, the server reduces computational load by limiting deep processing to filtered candidate sets, and by reusing intermediate feature vectors instead of recomputing them for each query. The server decreases communication overhead by sending compact prompt sentences that embed only relevant numerical scores and selected attributes, rather than transmitting raw database contents. The server improves data management by unifying historical assignment records, real-time status data, and feedback in a single schema that supports both low-latency queries and training data extraction.

Moreover, the server implements a non-conventional decision-making algorithm that integrates neural network scoring with generative reasoning. The neural network captures high-dimensional correlations between tasks and personnel, while the generative AI model converts structured scores and attributes into human-readable rationales. This division of labor differs from simple rule-based systems and enables more accurate and explainable recommendations. The server's closed-loop feedback mechanism further refines model parameters and prompt formats in response to real-world decisions, resulting in reduced error rates in subsequent assignment cycles and improved convergence of the learning process. In alternative embodiments, the server uses different neural network architectures such as recurrent networks or graph-based models to capture temporal sequences of assignments or relational constraints among personnel. The server may distribute computation across multiple processors or machines, with one subsystem dedicated to feature generation and neural inference, and another subsystem dedicated to generative AI interaction and prompt handling. The server may also support multiple types of work sites, from assembly lines to logistics centers, by altering configuration files and the skill taxonomy while reusing the same core processing modules.

In another variation, the terminal is integrated into fixed equipment on the work site, such as operator panels attached to production stations. The terminal then not only displays assignment proposals, but also controls actuators or signaling devices instructing workers to move to designated locations. In such configurations, the server's improved assignment accuracy and latency directly affect physical resource utilization and throughput of the production system.

Through these embodiments, the server, the terminal, and the user cooperate in a technical framework that transforms raw sensor readings and database records into optimized, explainable personnel assignments. The system achieves improvements in processing speed, assignment accuracy, and data consistency, and reduces communication and computational overhead by using specialized data encodings, machine learning methods, and adaptive prompt sentence generation for interaction with a generative AI model.

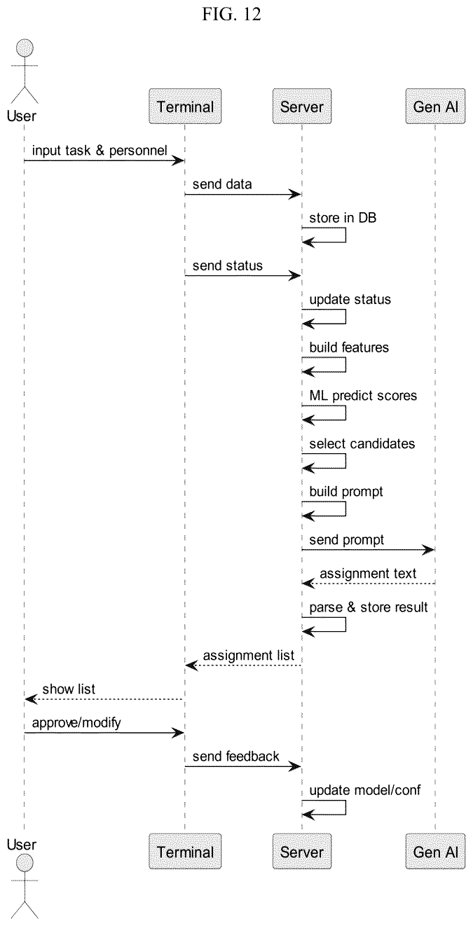

The following describes the processing flow using FIG. 12.

Step 1:

The server initializes system resources and data structures.

The server loads configuration data from storage as input, including skill lists, qualification lists, task categories, model file paths, and database connection parameters. The server creates or opens a database file and issues table-creation commands for task tables, personnel tables, status tables, and feedback tables. The server loads a trained machine learning model into memory from a model file and allocates internal buffers for feature vectors and inference results. Based on the configuration input, the server constructs in-memory indices and caches that will later accelerate queries and reduce repeated disk access. The output of this step is an initialized runtime environment in which subsequent steps can perform data ingestion, computation, and communication without reinitializing resources.

Step 2:

The user registers or updates task information through an input interface.

The user supplies task-related input data such as a task description, required skills, required qualifications, required experience years, and optional shift and location constraints via a graphical user interface or a form. The terminal collects this input, converts it into a standardized data structure, and sends it to the server as a request message. The server receives the request as input, validates required fields, converts multi-valued attributes into a canonical representation, and writes a new record into the task table or updates an existing record. The server outputs a stored task entry with a unique task identifier, which is subsequently used as a reference for feature generation and assignment computation.

Step 3:

The user registers or updates personnel information through an input interface.

The user provides personnel-related input including a personnel identifier, skills, qualifications, years of experience, preferences, and optional personality attributes. The terminal captures this information, formats it into a structured personnel record, and transmits it to the server. The server receives the record as input, normalizes textual fields, encodes lists of skills and qualifications into a storage format, and executes database insert or update operations on the personnel table. The output of this step is a set of persistent personnel records that can be joined with task records and status records during later analysis.

Step 4:

The terminal acquires real-time personnel status and sends it to the server.

The terminal receives as input sensor readings from an information acquisition device, such as code scans or tag reads, indicating personnel identifiers and their physical locations. The terminal may also receive user selections for current status such as “available” or “busy.” The terminal combines these inputs into a status message that includes a personnel identifier, location information, activity status, and a timestamp, and sends this message to the server over a network connection. The server takes this message as input, checks its format, and stores or updates corresponding entries in the personnel status table. The output of this step is an updated set of real-time status records reflecting the current deployment of personnel in the work site.

Step 5:

The server retrieves relevant task and personnel data for assignment computation.

The server receives as input a trigger condition, such as a new task registration, a change in personnel status, or a periodic timer event. In response, the server queries the database for open tasks that require assignment and for personnel who meet basic eligibility criteria such as appropriate qualifications and availability flags. The server performs relational joins or coordinated lookups between task records, personnel records, and status records. The server then outputs a set of task-personnel candidate pairs, each pair including all necessary raw attributes to be transformed into feature vectors in subsequent processing.

Step 6:

The server generates feature vectors for task-personnel pairs.

The server takes as input the candidate task-personnel pairs obtained from the database queries. For each pair, the server applies deterministic encoding rules: the server maps categorical values such as skills to vector positions, sets corresponding elements to 1 or to weighted values, normalizes numerical values such as years of experience, and encodes compatibility between personnel preferences and task constraints as additional numeric features. The server concatenates task and personnel vectors to form composite feature vectors. The output of this step is a batch of numerical feature vectors, each associated with a specific task-personnel pair, ready for processing by the machine learning model.

Step 7:

The server computes numerical suitability values using the machine learning model.

The server receives the batch of feature vectors as input to the machine learning inference module. The server feeds these vectors into the neural network by performing a series of matrix multiplications and non-linear activation operations defined by the network architecture. In one example, the server multiplies the input vectors by weight matrices for hidden layers, adds bias terms, applies activation functions, and finally computes an output score for each pair. The server executes these computations in a batched manner to reduce overhead and to leverage underlying numerical libraries. The output of this step is a corresponding batch of numerical suitability values, each indicating how well a given personnel record matches a given task.

Step 8:

The server selects candidate personnel for each task based on suitability values and constraints.

The server takes as input the numerical suitability values and the associated task-personnel identifiers, along with any hard constraints such as required certifications and maximum assignment count per person. The server filters out task-personnel pairs that violate constraints, then sorts the remaining pairs in descending order of suitability for each task. The server then selects the top-ranked personnel or all personnel exceeding a configured threshold. The server may also apply conflict resolution logic to avoid overlapping assignments. The output of this step is a shortlist of candidate personnel for each task, each candidate annotated with its suitability score and relevant attributes.

Step 9:

The server constructs a prompt sentence for a generative AI model using numerical and textual context.

The server receives as input the shortlisted candidate personnel, associated tasks, and their suitability scores. For each task, the server gathers detailed attribute information such as required skills, qualifications, experience requirements, and candidate personnel profiles including skills, qualifications, experience, preferences, and current status. The server then formats these attributes and scores into a natural-language description. The server appends explicit instructions about the desired output structure and explanation style. The server combines task descriptions, candidate descriptions, and suitability scores into a unified prompt sentence. The output of this step is a text-based prompt sentence suitable for providing structured context to a generative AI model.

Step 10:

The server transmits the prompt sentence to an external generative AI model and receives assignment proposal information.

The server uses the generated prompt sentence as input to a communication interface that connects to an external generative AI model hosted on remote computing resources. The server sends a request containing the prompt sentence and model selection parameters, and then waits for a response. The external generative AI model processes the prompt and generates textual output that includes recommended personnel for each task and explanation of the reasons. The server receives this textual output as input and, if necessary, cleans up formatting artifacts. The output of this step is a set of assignment proposal texts that can be parsed and transformed into structured internal records.

Step 11:

The server parses assignment proposal texts and creates structured assignment records. The server takes the generative AI output as input and applies parsing rules based on expected key phrases and delimiters specified in the prompt instructions. The server identifies task identifiers, recommended personnel identifiers, and explanation segments. The server then maps each extracted element to internal fields, linking tasks to selected personnel and associating each link with the corresponding neural network suitability score and the generative explanation. The server writes these records into an assignment table or stores them in an in-memory data structure. The output of this step is a structured representation of proposed assignments that can be readily served to terminals and used for feedback collection.

Step 12:

The terminal retrieves structured assignment records and displays them to the user. The terminal sends a request to the server as input, indicating which tasks or areas the user wishes to review. The server responds by providing the structured assignment records as output, including task descriptions, recommended personnel, and explanation texts. The terminal takes this data as input and renders it in a user interface, grouping recommended assignments by task or by personnel. The terminal displays key fields such as task identifiers, personnel identifiers, suitability scores, and natural-language explanations, and presents interactive controls for approval or modification. The output of this step is a visible and interactive assignment list that the user can act upon.

Step 13:

The user reviews proposed assignments and provides approval or modification decisions. The user receives the displayed assignments as input and examines task descriptions, recommended personnel, and textual explanations. Based on this information, the user selects actions, such as accepting an assignment, rejecting it, or reassigning a task to a different person from an available list. The user may also enter comments that explain the reasoning behind modifications. The terminal captures these user actions and comments as structured decision data. The output of this step is a set of approval and modification messages that encode the user's decisions in a form suitable for server-side processing.

Step 14:

The terminal transmits user decisions to the server for feedback integration.

The terminal takes the approval and modification messages as input and sends them to the server over the network. Each message includes identifiers for the task and personnel, the decision type (approved or modified), and optional comment text. The server receives these messages as input and validates that the referenced tasks and personnel exist in its database. The server then records each decision in a feedback table, associating it with the original assignment proposal and timestamping it. The output of this step is an updated set of feedback records that reflect real-world acceptance or correction of proposed assignments.

Step 15:

The server analyzes feedback data and updates model and prompt parameters.

The server periodically takes feedback records as input, along with historical suitability scores and assignment outcomes. The server computes statistics, such as acceptance rates for different score ranges or for different attribute combinations, and uses these statistics to adjust configuration parameters such as score thresholds and filtering conditions. The server may also compile training batches that incorporate feedback as labels for successful or unsuccessful predictions and perform additional training iterations on the neural network to refine its weights. Furthermore, the server edits prompt templates to emphasize or de-emphasize attributes that appear important or unimportant in accepted decisions. The output of this step is an updated configuration, including revised model parameters and prompt generation rules, that improves the accuracy and relevance of future assignment proposals.

Step 16:

The server reuses updated configurations in subsequent assignment cycles.

The server uses the adjusted model parameters, thresholds, and prompt templates as input the next time it performs feature generation, suitability computation, candidate selection, and prompt construction. Because the server now relies on modified weights and refined instructions, the internal numerical computations and resulting text prompts are altered in a way that better aligns with observed user decisions. The output of this step is an enhanced assignment pipeline that produces more accurate suitability scores, more contextually appropriate prompt sentences for the generative AI model, and more acceptable assignment proposals for the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional personnel assignment support systems predominantly rely on static rule-based engines or simple matching algorithms that compare predefined attributes of persons and jobs. Such systems are typically implemented as independent components that (i) accept manually curated profiles, (ii) perform keyword or score-based matching, and (iii) output recommended assignments based on fixed logic. These approaches suffer from several technical limitations in terms of computer technology itself.

First, existing systems do not efficiently integrate heterogeneous person-related data and job-related data into a form that can be directly and effectively consumed by a generative AI model executed by a computer. Person information such as experience, achievements, preferences, and personality is often stored as unstructured or semi-structured text, whereas job-related information such as work content, required capabilities, qualifications, and experience values is stored in separate databases with different schemas. As a result, the processing device must perform ad hoc data retrieval and transformation operations each time a recommendation is requested, leading to duplicated processing, inefficient use of memory, and increased latency.

Second, conventional systems typically treat the generative AI model, if used at all, as a loosely coupled external service invoked by a generic natural language query. In such architectures, the preparation of the prompt sentence for the generative AI model is left to manual human input or simplistic concatenation of text, without systematic normalization and combination of the underlying structured data maintained in the database. This often results in prompt sentences that are incomplete, inconsistent, or redundant, causing the generative AI model to produce unstable or suboptimal outputs. From a computer-technical perspective, the lack of a defined internal representation (evaluation target information) and a standardized prompt generation pipeline prevents efficient and reliable interaction between the processor, the database system, and the generative AI model.

Third, previous systems generally fail to leverage precomputed suitability indices between multiple persons and multiple jobs as an intermediate representation for constraining the input to the generative AI model. In conventional architectures, each recommendation request may trigger a full comparison between all available persons and jobs, imposing significant computational overhead on the processor and storage subsystem. The absence of a structured suitability index also hampers efficient selection of candidate job information prior to AI inference, resulting in unnecessary data transfer, increased CPU cycles, and higher response times.

Fourth, when handling use cases such as assignment changes, job applications, or job transfers, existing systems lack a unified mechanism to (i) retrieve the relevant person information and job-related information from a database, (ii) compose a contextually rich but computationally compact prompt sentence, and (iii) systematically feed this prompt to the generative AI model in a reproducible way. As a consequence, the processor and memory hierarchy are used in a suboptimal manner, and the system cannot consistently provide high-quality assignment suggestions at scale.

Accordingly, there is a need for an improved computer-implemented system that technically integrates (1) structured storage of person and job-related information in a relational information management device, (2) automated generation of evaluation target information combining such structured data, (3) systematic construction of prompt sentences for a generative information processing model based on the evaluation target information and suitability indices, and (4) efficient execution of the generative information processing model to produce machine-usable job recommendation outputs. The objective is to enhance the performance, reliability, and scalability of the overall computing system that performs suitable-person suitable-position recommendations, by reorganizing data structures and processing flows in a manner that improves how the computer stores, retrieves, transforms, and utilizes data and AI models.

The specific processing by the specific processing unit 290 of the data processing device 12 in Example 2 is realized by the following means.

The present invention provides a server comprising a processor and a memory storing instructions that, when executed by the processor, cause the processor to acquire, from an information input/output device operated by a user, person information including experience information, achievement information, preference information, and personality information regarding a person, and job-related information, convert the acquired person information into structured information, and transmit the structured information as a request message in accordance with a communication protocol; to receive the request message, decode encrypted communication included in the request message, parse the structured information to extract the person information, convert the extracted person information and the job-related information into registration commands for a relational information management device, and store the person information and the job-related information as an information set in the relational information management device; to acquire, from the information set, the person information and the job-related information, and generate evaluation target information corresponding to the person by combining the experience information, the achievement information, the preference information, and the personality information included in the person information with work content information, required capability information, qualification information, and experience value information included in the job-related information; to format the evaluation target information into natural language, generate a prompt sentence including a problem description for presenting job candidates suitable for the person, and supply the prompt sentence as an input to a generative information processing model and execute the generative information processing model; to acquire a response sentence output from the generative information processing model, the response sentence indicating one or more job candidates for the person and reasons therefor, convert the response sentence into display information, and transmit the display information to the information input/output device; and to, for a plurality of items of person information and a plurality of items of job-related information stored in the information set, compare and analyze the experience information, the achievement information, the preference information, and the personality information with the work content information, the required capability information, the qualification information, and the experience value information, calculate, based on a result of the comparison, a suitability index for each person, and select, as a candidate of the evaluation target information to be input to the generative information processing model, job-related information whose suitability index satisfies a predetermined condition. This enables the computing system to internally normalize heterogeneous person and job-related data into structured evaluation target information, to automatically and consistently generate prompt sentences for the generative information processing model based on suitability-constrained data subsets, and to thereby reduce redundant computations, improve the efficiency and stability of AI-based recommendation processing, and enhance overall computer performance and scalability in generating suitable-person suitable-position proposals.

The term “processor” refers to a hardware computing element, such as a central processing unit or a graphics processing unit, that executes instructions to perform data processing, control, and communication functions of the system.

The term “memory” refers to one or more non-transitory computer-readable storage media that store instructions and data to be executed or processed by the processor.

The term “information input/output device” refers to an electronic apparatus, such as a terminal, client device, or user interface device, that enables a user to input information into the system and receive information output from the system.

The term “user” refers to a human operator who interacts with the information input/output device to input person information, job-related information, and instructions, and to receive job recommendation results.

The term “person information” refers to information associated with an individual person, including experience information, achievement information, preference information, and personality information.

The term “experience information” refers to information indicating past roles, responsibilities, or work histories of a person, including duration, position, and type of work performed.

The term “achievement information” refers to information indicating results, accomplishments, or performance outcomes obtained by a person, such as sales results, project completions, or performance metrics.

The term “preference information” refers to information indicating desired conditions, aspirations, or interests of a person regarding work assignments, such as preferred job types, departments, or career directions.

The term “personality information” refers to information indicating behavioral traits, interpersonal characteristics, or personal tendencies of a person, such as communication style, proactiveness, or team orientation.

The term “job-related information” refers to information associated with a job, position, or work assignment, including work content information, required capability information, qualification information, and experience value information.

The term “work content information” refers to information describing tasks, responsibilities, and activities to be performed in a particular job or work assignment.

The term “required capability information” refers to information indicating skills, competencies, or abilities required to perform a particular job or work assignment.

The term “qualification information” refers to information indicating certifications, licenses, or formal recognitions required or preferred for a particular job or work assignment.

The term “experience value information” refers to information indicating a desired or required level of prior experience, such as years in a role or exposure to certain tasks, for a particular job or work assignment.

The term “structured information” refers to information represented in a predefined format or schema, such as a key-value structure, table structure, or markup structure, that can be systematically parsed and processed by the processor.

The term “request message” refers to a communication unit transmitted in accordance with a communication protocol, including structured information encapsulated in a message format such as a network request.

The term “communication protocol” refers to a set of rules and formats governing data exchange between the information input/output device and the server, including protocols such as HTTP, HTTPS, or equivalent network communication standards.

The term “encrypted communication” refers to communication data that has been transformed by an encryption algorithm to protect confidentiality during transmission over a network.

The term “relational information management device” refers to an information management system, such as a relational database management system, that stores and manages data in tables with defined relationships.

The term “information set” refers to a logically related collection of stored data items, including person information and job-related information, maintained in the relational information management device.

The term “evaluation target information” refers to information generated by combining person information with job-related information for a specific person, used as an internal representation to evaluate suitability between the person and one or more jobs.

The term “natural language” refers to a human language representation, such as sentences or phrases, that can be read and understood by human users and processed as text by the generative information processing model.

The term “prompt sentence” refers to a natural language text sequence provided as an input to the generative information processing model, the text sequence including at least a description of person information, job-related information, and a problem description indicating a requested output.

The term “problem description” refers to a portion of a prompt sentence that describes a task to be solved by the generative information processing model, such as requesting job candidates suitable for a particular person.

The term “generative information processing model” refers to a machine learning model, such as a generative AI model, configured to generate text or other data based on input information including a prompt sentence.

The term “response sentence” refers to a natural language text sequence output by the generative information processing model in response to a prompt sentence, the text sequence indicating one or more job candidates and reasons therefor.

The term “display information” refers to information formatted for presentation on the information input/output device, including textual, graphical, or structured data derived from the response sentence.

The term “suitable job proposal” refers to an output presented to the user that indicates one or more job assignments or positions determined to be appropriate for a person based on evaluation target information and processing by the generative information processing model.

The term “plurality of items of person information” refers to two or more sets of person information each associated with a different person or profile.

The term “plurality of items of job-related information” refers to two or more sets of job-related information each associated with a different job, position, or work assignment.

The term “suitability index” refers to a numerical value or ordered measure calculated based on comparison and analysis between person information and job-related information, the numerical value or measure indicating a degree of suitability of a person for a job.

The term “predetermined condition” refers to a threshold, rule, or criterion specified in advance and used to select job-related information whose suitability index satisfies a required level or constraint.

The term “assignment policy” refers to information describing a guideline, strategy, or constraint to be applied when assigning a person to a job or work assignment.

The term “application admissibility” refers to information indicating whether a person is permitted, recommended, or suitable to apply for a particular job or work assignment.

The term “transfer candidate” refers to information indicating a job, department, or position that is proposed as a potential destination in a job transfer or reassignment for a person.

The term “suitable-person suitable-position information” refers to information generated by the system that indicates pairings between persons and jobs considered suitable based on evaluation target information, suitability indices, and outputs of the generative information processing model.

The server implements the invention as a network-accessible computing platform that cooperates with one or more terminals operated by users. The server comprises at least one processor, a main memory, a non-transitory storage device, a network interface, and a relational information management device implemented as a relational database management system. The server executes an operating system such as a general-purpose server operating system and middleware including a web server and an application server. The server further executes an application program that implements the functions described below.

The terminal comprises a processing unit, a memory, a display device, and an input device such as a keyboard or a pointing device. The terminal executes a web browser application that communicates with the server over a computer network using a communication protocol such as HTTPS. The terminal presents a graphical user interface that allows a user to input person information and to view generated job proposals.

The user operates the terminal to access a web page or application screen provided by the server. The user inputs person information including experience information, achievement information, preference information, and personality information regarding a person, and job-related constraints or preferences, into designated input fields. For example, the user may input:

“Experience: project leader for 5 years in software product development.

Achievements: achieved more than 120 percent of sales targets for three consecutive years. Preferences: wants to challenge new business development in a technology-oriented division. Personality: high communication skills, proactive, and team-oriented.”

The terminal converts the input values into a structured representation in accordance with a data schema defined by the server and transmits this representation to the server as a request message over an encrypted channel such as TLS.

The server receives the request message via the network interface and decodes the encrypted communication using a cryptographic library. The server parses the structured representation using a parser component and extracts the person information and associated job-related information. The server normalizes text values by applying text preprocessing operations such as lowercasing, removal of control characters, and mapping of synonymous terms to canonical terms. The server then converts the normalized data into database records compatible with the relational information management device.

The server uses a relational database management system, for example a SQL-based database engine, as the relational information management device. The server defines relational tables for person entities, job entities, and linking relations. The server stores each item of person information and job-related information as rows in these tables. The server maintains indexes on selected columns such as person identifiers, skill types, and job categories in order to accelerate retrieval operations. By structuring the information as relational data, the server ensures that subsequent retrieval and comparison operations can be executed using optimized query plans at the database engine level, which reduces computational overhead and disk access time.

The server retrieves stored data from the relational information management device and generates evaluation target information by combining person information with job-related information. The server executes queries that join tables containing experience information, achievement information, preference information, and personality information with tables containing work content information, required capability information, qualification information, and experience value information. The server represents the evaluation target information in an intermediate data structure that separates semantic categories (such as “experience,” “required capability,” and “qualification”) and encodes them with attribute identifiers. This structured intermediate representation allows the server to selectively include or exclude subsets of attributes based on system policies and to support different generative AI models without redesigning the database schema.

The server calculates a suitability index for each candidate pair of person and job by applying an algorithm that compares the attributes in the evaluation target information. The server may, for example, compute similarity scores between skill vectors, count exact matches of required qualifications, and measure alignment between preference information and work content information. The server may implement these operations using numeric feature vectors and distance metrics, such as cosine similarity, or rule-based scoring tables stored in the relational database. The suitability index is stored as additional data in the relational information management device, which allows the server to filter and rank candidate jobs for a person before invoking the generative AI model. This preselection reduces the number of candidate jobs that must be processed by the generative AI model, thereby reducing computational load, memory usage, and input sequence length.

The server formats the evaluation target information into natural language and generates a prompt sentence for the generative AI model. The server uses a template-based prompt generation module that maps structured attributes to natural language segments. For example, the server may generate the following prompt sentence:

“Employee profile:
Experience: project leader for 5 years in software product development.
Achievements: achieved more than 120 percent of sales targets for three consecutive years.
Preferences: wants to challenge new business development in a technology-oriented division.
Personality: high communication skills, proactive, and team-oriented.

Job candidates (preselected based on structured matching):
1. New business development project in the cloud solutions division, requiring project leadership and client negotiation skills.
2. Product launch project in the enterprise services division, requiring cross-functional coordination and sales enablement experience.

Task:

Based on the above employee profile and job candidates, select the most suitable job for this employee and explain the reasons. Output the job title, the expected role, and a concise justification.”

The server constructs such prompt sentences by inserting retrieved job descriptions and computed suitability indices into the prompt template. The server may include indicators of the suitability index, for example “high suitability,” “medium suitability,” or “low suitability,” to guide the generative AI model toward more relevant candidates while reducing the need for the generative AI model to process all available job records. By encapsulating precomputed suitability and structured information in the prompt sentence, the server constrains the generative AI model's search space and improves both the quality and consistency of its outputs.

The server implements the generative information processing model as a generative AI model deployed in the server environment. The server uses a neural network architecture, such as a transformer-based language model, implemented by an AI framework such as TensorFlow or PyTorch. The server stores model parameters in non-transitory storage and loads them into main memory and, if available, accelerator hardware such as a graphics processing unit. The server applies a tokenization algorithm, such as a subword-based tokenizer, to convert the prompt sentence into a sequence of tokens. The server then converts the tokens into numeric vectors using an embedding matrix and feeds these vectors into the transformer network. The server configures the transformer network to include multiple layers of self-attention and feedforward sub-layers. The server uses learned attention weights to compute contextual representations of each token based on the entire prompt, including both the employee profile and the job candidates. The server applies positional encodings to preserve token order and uses residual connections and normalization operations to stabilize training and inference. The server executes the forward pass of the network to produce probability distributions over the next token at each step of the generated output sequence. The server uses sampling parameters such as maximum output length, temperature, and top-k or top-p sampling to control diversity and determinism of the generated response sentence.

The server trains or fine-tunes the generative AI model on a corpus that includes examples of person-job matching and explanatory text. The server uses a loss function such as cross-entropy loss between predicted tokens and ground truth tokens. The server updates model parameters using an optimization algorithm such as stochastic gradient descent with adaptive learning rates. The server may apply regularization techniques such as dropout and weight decay and may use data augmentation techniques by paraphrasing text segments or perturbing non-critical attributes to increase training data diversity. These training and fine-tuning procedures enable the model to learn patterns that relate structured person information and job-related information to meaningful job proposals and explanations.

The server, during inference, uses the trained parameters without further learning. The server controls the generative AI model through the prompt sentence; no separate rules are manually encoded for each combination of attributes. This approach differs from human rule-making and conventional rule-based systems. Instead, the server exploits learned representations of patterns to infer complex relationships between attributes, allowing it to generate recommendations that would be difficult to specify exhaustively using hand-written rules. This yields improved accuracy of recommendations compared to simple rule-based or keyword-based matching, particularly when combining multiple factors such as experience, achievements, preferences, and personality.

The server post-processes the response sentence output by the generative AI model. The server parses the text to extract structured elements such as job title, role, and justification using pattern recognition or lightweight natural language parsing techniques. The server validates that the generated job candidate corresponds to one of the candidates provided in the prompt or to a known job record in the relational information management device. If the response refers to an unknown job name, the server may map it to the closest known job using string similarity or semantic similarity based on vector representations. This mapping step prevents the system from proposing assignments that cannot be realized within the existing job catalog and thus improves practical usability and consistency.

The terminal receives the formatted display information from the server and renders a user interface comprising the proposed job, the proposed role, and the explanation. The user views the recommendation and may provide feedback, such as accepting the proposal, rejecting it, or requesting alternative suggestions. The terminal transmits feedback to the server as structured data. The server may store this feedback and use it in future updates of the generative AI model or matching algorithm, thereby refining the system's behavior over time. The server improves computer technology itself in several ways. By storing person information and job-related information in a relational information management device and by computing suitability indices before invoking the generative AI model, the server reduces the input size and complexity of the prompt sentence. This leads to shorter token sequences and less processing time in the transformer network, thereby improving processing speed and reducing memory consumption. By precomputing suitability indices using numeric operations and storing them as indexed values, the server enables rapid retrieval and filtering of candidate jobs, which reduces the need for expensive full-table scans and improves query efficiency.

The server also improves the accuracy and stability of AI-based recommendations by structuring the data flow. The use of an intermediate evaluation target information representation and a standardized prompt template ensures that the generative AI model receives consistent and comprehensive context across different requests. This reduces variance in model output caused by inconsistent or incomplete prompts and leads to more predictable system behavior. The server's architecture localizes changes to the prompt template or suitability computation without requiring reconfiguration of the database schema, improving maintainability and extensibility of the computing system.

The server further reduces communication overhead between the terminal and the server by transmitting structured data rather than full natural language descriptions at each interaction. The server generates most of the prompt sentence on the server side based on the stored evaluation target information, instead of requiring the user or the terminal to compose detailed textual queries. This design reduces network bandwidth usage and latency, and shifts heavy text composition and AI inference to the server where optimized hardware and software can be deployed.

The system is not limited to a single implementation. In one embodiment, the server executes the generative AI model locally on a processor or an accelerator device. In another embodiment, the server communicates with a remote generative AI service via an application programming interface, while still performing the structured data preparation, suitability index computation, and prompt formatting locally. In a further embodiment, the server deploys multiple generative AI models with different sizes and capabilities and selects an appropriate model based on the length and complexity of the evaluation target information, thereby optimizing resource consumption.

The terminal can be implemented as a desktop computer, a portable computer, a tablet, or a smartphone, and the user interface can be realized as a web application or as a native application. The specific hardware and software components, such as the particular relational database engine or the specific AI framework used to implement the generative AI model, may be varied without departing from the technical ideas described herein. The essential feature is that the server integrates structured storage, suitability-based preselection, standardized prompt sentence generation, and constrained generative inference in a manner that improves the efficiency, reliability, and scalability of computer-based person-job matching and job proposal generation.

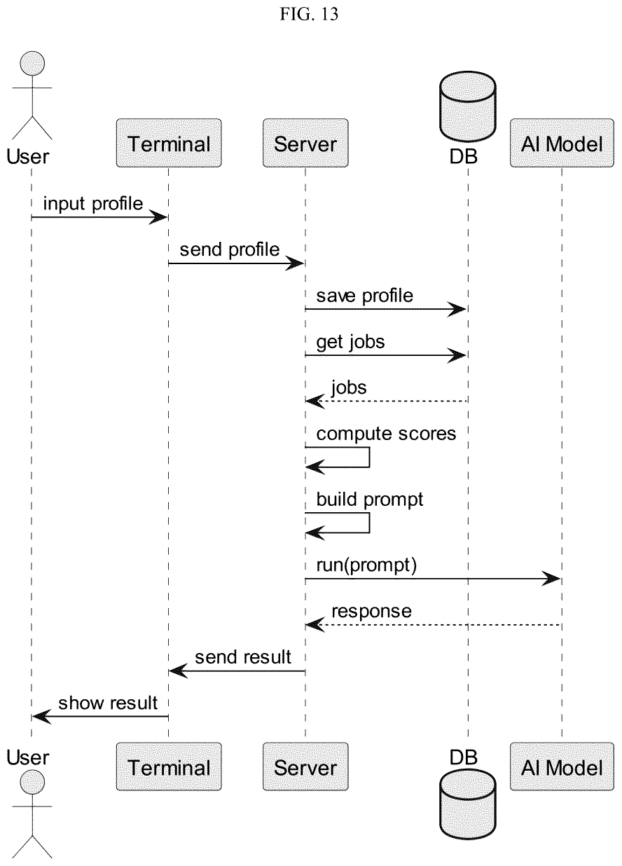

The following describes the processing flow using FIG. 13.

Step 1:

The user operates the terminal to input person information and job-related preferences. The terminal displays input fields for experience information, achievement information, preference information, and personality information, and optionally for desired job type, department, or location.

Input: raw keystrokes and selection events entered by the user into the graphical user interface.

The terminal aggregates these values into an internal data structure representing a person profile and associated constraints.

Output: a structured person profile and constraint object held in the terminal's working memory.

Step 2:

The terminal converts the person profile and constraints into a structured payload and sends a request to the server.

The terminal serializes the internal data structure into a structured format, applies basic validation (for example, non-empty required fields, simple type checks), and embeds the serialized data as a message body in a network request. The terminal then establishes an encrypted channel (for example, TLS) and transmits the request to the server using a network protocol such as HTTPS.

Input: structured person profile and constraint object in the terminal's working memory. The terminal performs data formatting, serialization, and encryption based on a communication protocol specification.

Output: an encrypted request message containing structured person and constraint information, transmitted over the network to the server.

Step 3:

The server receives the request message and decodes the structured person information. The server terminates the encrypted session using a cryptographic library, extracts the message body from the network packet, and parses the structured payload using a parser component. The server validates field presence, normalizes text (for example, lowercasing, whitespace trimming), and maps certain terms to canonical forms (for example, mapping “sales manager” and “account manager” to a unified internal role category).

Input: encrypted request message containing the structured payload.

The server performs decryption, parsing, validation, and normalization to convert the message into an internal representation.

Output: a normalized person information object and a normalized constraint object in the server's application memory.

Step 4:

The server stores the normalized person information and associated data in a relational information management device.

The server constructs insert or update commands for relational tables representing persons, skills, achievements, preferences, personality traits, and constraints. The server uses a database driver to execute these commands on a relational database engine. The server may create or update index entries to accelerate future lookups.

Input: normalized person information object and constraint object in the server's application memory.

The server performs data mapping from application-level objects to relational rows and executes write operations on the database.

Output: persistent person records and related rows stored in the relational database, accessible via structured queries.

Step 5:

The server retrieves relevant job-related information and existing person information as evaluation candidates.

The server issues query commands to the relational database to obtain job-related information including work content information, required capability information, qualification information, and experience value information, as well as any previously stored person information required for comparison. The server may filter jobs by constraints such as department, location, or job type to reduce the candidate set.

Input: constraint object and person identifier (or profile fields) in server memory, plus relational tables in the database.

The server performs query generation, execution, and result parsing to construct candidate sets.

Output: a list of candidate job-related information objects and the corresponding person information object loaded into server memory.

Step 6:

The server computes suitability indices between the person information and each candidate job-related information object.

The server transforms selected attributes (such as skills, experiences, and requirements) into numeric or categorical feature vectors, then applies comparison operations such as similarity measures, weighted scoring, or rule-based matching. For example, the server may calculate a weighted sum of skill matches, required qualification matches, and preference alignment, and may normalize the result to a predefined range.

Input: person information object and a list of candidate job-related information objects. The server performs feature extraction, numeric calculations (such as vector operations and weighted sums), and rule evaluations to generate scores.

Output: a set of suitability indices, each associated with a specific person-job pair, stored in server memory and optionally persisted in the database.

Step 7:

The server selects a subset of job-related information based on the suitability indices. The server ranks candidate jobs by their suitability index, applies thresholds or ranking criteria (for example, top N jobs above a minimum score), and discards jobs that do not meet a predetermined condition. This selection reduces the number of candidates that must be encoded into the subsequent prompt sentence.

Input: a set of suitability indices and associated job-related information objects.

The server performs sorting, thresholding, and filtering operations on numeric suitability values.

Output: a reduced list of selected job-related information objects designated as candidates for inclusion in evaluation target information.

Step 8:

The server generates evaluation target information by combining the person information with the selected job-related information.

The server builds an intermediate data structure that groups attributes by category (experience, achievements, preferences, personality, work content, required capabilities, qualifications, experience values) and associates each job candidate with its corresponding suitability index. The server may encode each candidate as a record containing a job identifier, a description, required capabilities, and a summarized suitability label (for example, “high suitability”).

Input: person information object, selected job-related information objects, and suitability indices for each selected job.

The server performs data aggregation, field grouping, and label assignment operations.

Output: an evaluation target information object encapsulating both the detailed person profile and a constrained set of candidate job descriptions with associated indices.

Step 9:

The server formats the evaluation target information into natural language and generates a prompt sentence for the generative AI model.

The server applies template-based text generation rules that map fields from the evaluation target information object to natural language segments. For example, the server generates a structured text including an “Employee profile” section and a “Job candidates” section. The server then appends a “Task” section that explicitly instructs the generative AI model what result to produce.

Input: evaluation target information object containing structured person and job data.

The server performs string concatenation, token substitution, and ordering operations according to predefined templates.

Output: a prompt sentence (or prompt text block) expressed in natural language, stored in server memory as a character string.

Step 10:

The server prepares model input tensors for the generative AI model based on the prompt sentence.

The server tokenizes the prompt sentence using a subword or wordpiece tokenizer, maps tokens to numeric token IDs, and constructs input tensors representing token sequences and optional attention masks. The server may truncate or segment overly long text to satisfy model input length constraints.

Input: prompt sentence as a text string and tokenizer configuration.

The server performs lexical segmentation, index lookup in a vocabulary table, and tensor construction operations.

Output: numeric input tensors representing the prompt sentence, suitable for consumption by the generative AI model.

Step 11:

The server executes the generative AI model using the input tensors to produce a response sentence.

The server feeds the tensors into a transformer-based neural network implemented in an AI framework. The server performs a forward pass through multiple attention and feedforward layers, computing contextual representations and predicting probability distributions over possible next tokens. The server iteratively samples or selects tokens according to decoding parameters such as temperature and top-k or top-p values until an end condition is met.

Input: input tensors representing the prompt sentence and model parameters stored in memory.

The server performs matrix multiplications, nonlinear activations, attention weight calculations, and probabilistic decoding steps to generate an output token sequence.

Output: an output token sequence representing the generated response sentence in token ID form.

Step 12:

The server converts the generated token sequence into a natural language response sentence and post-processes the content.

The server maps output token IDs back to text segments using the tokenizer's vocabulary, concatenates them into a sequence of characters, and normalizes spacing and punctuation. The server may then parse the text to identify job titles, roles, and justifications using pattern-matching rules or lightweight parsing, and may verify that referenced jobs match known entries in the relational database.

Input: output token sequence representing the generated text.

The server performs de-tokenization, text normalization, and pattern-based extraction operations.

Output: a structured response object containing a response sentence and extracted elements such as recommended job, recommended role, and explanation, plus a cleaned display string.

Step 13:

The server constructs display information based on the structured response object and transmits it to the terminal.

The server encapsulates the recommended job title, role, and explanation into a display-oriented data structure, for example by assigning them to labeled fields expected by the terminal interface. The server then serializes this structure into a response message and transmits the message to the terminal over the network via an encrypted channel.

Input: structured response object and display formatting rules.

The server performs field mapping, serialization, and encryption operations.

Output: an encrypted response message containing display information for the recommendation.

Step 14:

The terminal receives the response message and renders the recommendation for the user. The terminal decodes the encrypted channel, parses the response payload, and extracts the fields corresponding to the recommended job, role, and explanation. The terminal updates the graphical user interface to show the recommendation, for example by displaying the job title in a prominent format and the explanation in a descriptive text area.

Input: encrypted response message from the server.

The terminal performs decryption, parsing, and user interface update operations.

Output: a visual presentation of the job recommendation on the display device.

Step 15:

The user reviews the presented recommendation and optionally issues follow-up instructions. The user examines the proposed job, role, and justification on the terminal and may decide to accept the recommendation, request alternative proposals, or modify input conditions. The user interacts with interface elements such as buttons or forms to send feedback or additional constraints to the server.

Input: visual presentation of the recommendation and user's intention.

The user performs decision-making and input actions on the terminal's interface.

Output: new user inputs or instructions that may trigger another execution of the server-side processing flow with updated parameters.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented personnel allocation and task assignment systems typically perform rule-based matching between stored job requirements and static user profiles. In many implementations, a processor retrieves simple attribute fields from a storage device, executes predetermined comparison logic, and outputs a recommended assignment. However, such systems suffer from several technical limitations.

First, conventional systems do not effectively integrate heterogeneous data types, such as structured job data, semi-structured user preference data, time-varying emotion state data, and sensor-derived apparatus state data. As a result, the processor often executes multiple disconnected processing pipelines and cannot construct a unified representation suitable for advanced reasoning. This leads to inefficient use of memory and processing resources, and increases latency when generating recommendations.

Second, in many systems, interaction with a generative AI model, if provided at all, is performed in an ad-hoc manner. A processor may pass raw database fields or minimally formatted text to an external model, which yields unstable or inconsistent outputs. Because prompt construction is not systematically tied to the underlying stored information, the system cannot reproducibly obtain high-quality recommendations, and the computation performed by the external model is not aligned with the internal data structures. This degrades the technical performance of the overall computing pipeline, including increased numbers of failed calls, unnecessary retries, and post-processing overhead.

Third, conventional systems generally treat the recommendation logic as static. They do not record a detailed correspondence between generated prompts, model outputs, user acceptance or rejection of recommendations, and subsequent execution status of tasks by machines. Consequently, the processor cannot adapt its prompt generation strategy or its internal recommendation rules based on historical outcomes. This lack of feedback-driven adaptation prevents the system from converging towards more efficient configurations over time and causes persistent waste in processor time, storage access, and network calls.

Fourth, in environments where terminal devices control apparatuses such as robots or work machines, existing systems typically decouple task recommendation from low-level apparatus control. The processor may output a recommended task in a human-oriented format, and a separate subsystem translates the task into control commands. This separation introduces redundant data conversion steps, increases the number of network transactions between components, and can cause inconsistencies between the recommended task and the actually executed task. Moreover, execution status of the apparatus is often not fed back into the recommendation engine in a structured way.

Accordingly, there is a need for a computer-implemented system in which a processor is configured to: (i) integrate diverse information sources, including work information, human-resource requirement information, user profile information, emotion information, and apparatus state information, into a structured data representation; (ii) systematically convert the structured data into a prompt sentence for a generative AI model; (iii) analyze responses from the generative AI model into machine-processable recommendation information; (iv) directly support generation of task information consumable both by user terminals and by apparatus control layers; and (v) adapt the prompt generation and recommendation generation conditions based on recorded history of execution status and user acceptance. By addressing these issues, the invention seeks to improve the functioning of the computer itself, including more efficient use of processing resources, reduced latency, and improved consistency and quality of recommendations in a closed feedback loop between storage, processing, model interaction, and apparatus control.

The specific processing by the specific processing unit 290 of the data processing device 12 in Application Example 2 is realized by the following means.

The present invention provides a server comprising a processor, a storage device, and an interface device, the processor being configured to store, in the storage device, work information and human-resource requirement information as management information; to receive, via the interface device, input information including experience information, performance information, preference information, and personality information of a user and store the input information in the storage device as user profile information; to obtain emotion state information of the user by supplying signals acquired from at least one of an imaging device and an audio acquisition device to an emotion analysis process and store the emotion state information in the storage device as emotion information; to obtain detection information representing an operational state of an apparatus or a work machine and store the detection information in the storage device as apparatus state information; to retrieve, from the storage device, at least a part of the work information, the human-resource requirement information, the user profile information, the emotion information, and the apparatus state information, and generate structured data by performing predetermined preprocessing on the retrieved information; to convert the structured data into a natural-language description and generate a prompt sentence including the natural-language description as an input sentence for a generative AI model; to transmit the prompt sentence to an external generative AI model, acquire response information from the external generative AI model, and analyze the response information to generate recommendation information including at least one of placement candidate information, work assignment information, and apparatus assignment information; and to structure the recommendation information as task information and generate output information for provision of the task information to at least one of a user terminal and a control target apparatus. This enables the computer system to implement an integrated pipeline in which heterogeneous operational data are normalized into a unified representation, converted into a prompt sentence optimized for a generative AI model, and translated back into structured task information, while execution results and user feedback are recorded and used to adapt subsequent prompt generation and recommendation conditions, thereby improving processing efficiency, recommendation stability, and coordination between user interfaces and apparatus control.

The term “work information” refers to information indicating tasks, jobs, operations, or activities to be performed in an organization, including at least one of task descriptions, required skills, required experience levels, constraints, and scheduling conditions.

The term “human-resource requirement information” refers to information indicating conditions or attributes desired for a person to perform a given work, including at least one of required qualifications, skills, experience, roles, and competency levels.

The term “management information” refers to information stored in a storage device for managing work information, human-resource requirement information, user profile information, emotion information, apparatus state information, and related data used by the processor for allocation and recommendation processing.

The term “user profile information” refers to information representing characteristics of a user, including at least one of experience information, performance information, preference information, and personality information of the user.

The term “experience information” refers to information indicating a history of work, roles, or activities previously performed by a user, including at least one of years of experience, types of tasks executed, and acquired skills.

The term “performance information” refers to information indicating results or outcomes achieved by a user, including at least one of success rates, quality metrics, productivity levels, and evaluation scores.

The term “Preference information” refers to information indicating a user's wishes, interests, or desired conditions regarding work, including at least one of preferred task types, desired career paths, and workload preferences.

The term “personality information” refers to information representing behavioral tendencies or psychological traits of a user, including at least one of collaboration style, risk tolerance, and inclination toward novelty or stability.

The term “emotion state information” refers to information indicating a current or recent emotional condition of a user, including at least one of labels such as joy, fatigue, anxiety, calmness, and corresponding confidence values.

The term “emotion information” refers to emotion state information stored in a storage device and associated with a user and a time point for use in subsequent processing.

The term “apparatus state information” refers to information indicating an operational condition of an apparatus or a work machine, including at least one of sensor values, error codes, utilization status, and maintenance status.

The term “detection information” refers to information acquired from one or more sensors or monitoring components of an apparatus or a work machine and used to derive apparatus state information.

The term “structured data” refers to data that has been organized into a predetermined schema or data structure, such as a record, table, or key-value set, allowing the processor to systematically process heterogeneous input information.

The term “natural-language description” refers to a text sequence in a human language that describes one or more elements of work information, user profile information, emotion information, and apparatus state information in a coherent, readable form.

The term “prompt sentence” refers to a natural-language text, including at least one natural-language description, that is generated by the processor as an input sentence to a generative AI model in order to obtain response information.

The term “generative AI model” refers to a computational model configured to generate output content, such as text, based on input data including a prompt sentence, by performing learned statistical or neural-network-based transformations.

The term “response information” refers to information output from a generative AI model in response to a prompt sentence, including at least one of recommended placements, task proposals, rankings, and explanatory text.

The term “recommendation information” refers to information derived by the processor by analyzing response information from a generative AI model and including at least one of placement candidate information, work assignment information, and apparatus assignment information.

The term “placement candidate information” refers to information indicating one or more candidate associations between users and roles or positions for performing work within an organization.

The term “work assignment information” refers to information indicating allocation of one or more tasks to one or more users, including at least one of task identifiers, assigned users, priorities, and time ranges.

The term “apparatus assignment information” refers to information indicating allocation of one or more tasks to one or more apparatuses or work machines, including at least one of apparatus identifiers, task identifiers, and operational parameters.

The term “task information” refers to a structured representation of recommendation information suitable for execution or display, including at least one of work assignment information and apparatus assignment information.

The term “output information” refers to information generated by the processor for provision to at least one of a user terminal and a control target apparatus, the information including task information and optionally explanation data.

The term “user terminal” refers to an information processing device operated by a user, including at least one of a workstation, a portable terminal, or a display device, configured to send input information to and receive output information from the server.

The term “control target apparatus” refers to an apparatus or work machine that executes at least part of a task based on task information received directly or indirectly from the server.

The term “terminal device” refers to an information processing device configured to communicate with the server, present task information to a user, and, in some embodiments, control an apparatus via intermediary control software.

The term “intermediary control software” refers to software that converts task information received from the server into apparatus control commands, including at least one of middleware, protocol adapters, and device drivers.

The term “execution status information” refers to information indicating progress or results of execution of a task by an apparatus or a user, including at least one of start time, completion time, error occurrence, and performance metrics.

The term “history information” refers to execution status information stored in a storage device together with related prompt sentences, recommendation information, and user acceptance information for use in subsequent analysis and adaptation.

The term “instruction sentence” refers to a natural-language text input by a user through an interface device to request a particular analysis, recommendation, or extraction operation from the server.

The term “constituent elements of the prompt sentence” refers to logical components of a prompt sentence, including at least one of a problem description, constraints, data summaries, and requested output formats.

The term “weighting of the prompt sentence” refers to an emphasis configuration used when constructing a prompt sentence, in which certain types of information, such as emotion information or performance information, are given higher or lower importance.

The term “template of the prompt sentence” refers to a predefined pattern or structure for composing a prompt sentence, including ordered segments and placeholders for inserting specific data values.

The term “generation rule of the recommendation information” refers to a rule set or algorithm by which the processor interprets response information from a generative AI model and converts it into structured recommendation information.

The term “acceptance information” refers to information representing how a user responded to recommendation information, including at least one of acceptance, partial modification, and rejection of a recommended placement or assignment.

The term “interface device” refers to a hardware or software component enabling data exchange between the processor and external entities, including at least one of network interfaces, input/output controllers, and user interface modules.

The term “storage device” refers to a memory component or a storage medium used to store management information, user profile information, emotion information, apparatus state information, task information, history information, and related data for processing by the processor.

In one embodiment, a server implements the claimed system by executing a computer program on a general-purpose computing platform including at least one central processing unit (CPU), a main memory, a non-volatile storage device, and a network interface. The server runs an operating system such as a general-purpose server operating system, and application software implemented, for example, in a programming language such as Python and executed within an application framework such as a web framework. The server communicates with one or more terminal devices via a communication network using a protocol such as HTTPS.

The server uses a relational database management system, such as a structured query language (SQL) database engine, as a storage device for management information. The server defines tables for work information, human-resource requirement information, user profile information, emotion information, apparatus state information, task information, and history information. For example, the work information table stores records with fields such as work_id, description, required_skill_vector, required_experience_level, and constraint_vector. The user profile table stores records with fields such as user_id, experience_vector, performance_metrics_vector, preference_vector, and personality_vector. The apparatus state table stores records with fields such as apparatus_id, timestamp, sensor_feature_vector, error_code, and maintenance_flag. These vector fields are stored as arrays or serialized numerical sequences, enabling efficient computation by the processor. The terminal is implemented as a workstation, a portable terminal, or another information processing device having a processor, a memory, a display, an input unit such as a keyboard or touchscreen, and optionally an imaging device and an audio acquisition device. The terminal executes a client application or web browser that provides a graphical user interface (GUI) to the user. The terminal sends user inputs and sensor signals to the server using HTTP requests and receives output information from the server, which the terminal renders as visual components such as tables, lists, and status indicators.

The user interacts with the system via the terminal. The user enters experience information, performance information, preference information, and personality information into input forms. The terminal converts these inputs into structured JSON documents and transmits them to the server. The server parses the JSON, validates the fields, converts free-text entries into normalized codes using predefined dictionaries, and stores the resulting records into the corresponding tables of the database. The server may also compute numerical feature vectors from categorical fields by applying one-hot encoding or embedding lookup operations, thereby enabling later numerical processing.

In an embodiment including emotion analysis, the terminal activates the imaging device and audio acquisition device during user interaction. The terminal samples image frames and audio segments and either transmits the raw signals to the server or executes an on-device feature extraction module. The feature extraction module computes facial landmark coordinates, facial action unit activations, voice pitch contours, energy spectra, and prosodic statistics. The terminal transmits these extracted features to the server. The server applies an emotion classification component, which may be implemented as a multi-layer neural network with an input layer corresponding to the concatenated visual and audio features, one or more hidden layers with non-linear activation functions such as rectified linear units (ReLUs), and an output layer with softmax activation providing probabilities over emotion categories such as joy, fatigue, anxiety, and calmness. The server stores the resulting emotion state information, together with a timestamp and a user identifier, in the emotion information table.

In an embodiment including apparatus control, the terminal connects to apparatuses, such as industrial robots or work machines, via intermediary control software. The intermediary control software may be a middleware framework. The terminal subscribes to topics or message channels that provide sensor data, including vibration levels, temperatures, joint positions, motor currents, and error codes. The terminal computes summary statistics over time windows (for example, mean vibration, maximum temperature, frequency of errors) and transmits these as sensor_feature_vectors to the server. The server stores these vectors in the apparatus state information table. By normalizing and compressing raw sensor streams into fixed-length feature vectors at the terminal, the system reduces network bandwidth usage and decreases processing load on the server, thereby improving communication efficiency. The server uses a modular software architecture. A data ingestion module receives input information and detection information from terminals, performs validation, normalization, and feature extraction, and writes records to the database. A preprocessing module retrieves relevant records using SQL queries, joins tables such as work information, user profile information, emotion information, and apparatus state information, and constructs structured data objects. These objects follow a predetermined schema, for example including fields: context_id, work_context_vector, user_context_vector, emotion_context_vector, apparatus_context_vector, and constraint_metadata.

The server uses a feature fusion algorithm to integrate heterogeneous information into a unified representation. For example, the server standardizes each numerical vector to zero mean and unit variance, concatenates vectors into a high-dimensional context vector, and optionally applies dimensionality reduction, such as principal component analysis (PCA) or a linear projection learned in advance, to obtain a compact context representation. This fused context vector enables the processor to compute similarities and constraints efficiently in a single vector space, avoiding multiple independent matching operations and reducing computational redundancy.

The server includes a prompt generation module that converts structured data into a natural-language prompt sentence. The prompt generation module is implemented as a rule-based text synthesis engine with templates and dynamic weighting. The server maintains multiple prompt templates, each specifying an ordered sequence of segments, such as “problem description segment,” “user profile summary segment,” “emotion summary segment,” “apparatus capability segment,” and “output format instruction segment.” Each segment contains placeholders for inserting specific values from the structured data, such as skill labels, years of experience, emotion labels, and apparatus capacities.

The server selects a template and determines weighting parameters for each segment based on configuration rules and history information. For example, if history information indicates that recommendations ignoring emotion states are frequently rejected by the user, the server increases the weighting of the emotion summary segment by choosing a variant of the template that elaborates on emotion information and by including explicit instructions for the generative AI model to consider emotion states strictly. Conversely, if the user often prioritizes apparatus availability, the server emphasizes apparatus capability information. This dynamic template and weighting selection constitutes a non-conventional rule-based algorithm that adapts prompt structure to feedback, improving both the stability and relevance of generative AI outputs.

The server then generates a prompt sentence. For example, the server may generate a prompt sentence such as:

“We have an employee with the following profile: skills=[project leadership, mechanical design], total experience=7 years, past performance=[two successful product launches], preferences=[wants to try new business development], personality=[high openness, high extroversion], current emotion state=[joyful and excited]. We have a work item: ‘launching a new product line in the robotics division’, required skills=[project management, coordination with manufacturing], required experience >=5 years, constraints=[completion within 6 months]. Considering all of this information, propose the most suitable role and main tasks for this employee in this work item, and explain your reasoning in a step-by-step manner.” In another example involving apparatus assignment, the server generates a prompt sentence such as:

“Apparatus A has sensor features indicating strong welding performance, stable vibration levels, and low error frequency in the past 30 days. Apparatus B has sensor features indicating moderate welding performance but higher throughput in inspection tasks. Given the following task types: [welding of steel components, visual inspection of assembled units], propose which apparatus should be assigned to each task type, and explain the reasons based on the apparatus state information.”

The server sends the prompt sentence to an external generative AI model via an application programming interface (API). The generative AI model is implemented, for example, as a large-scale neural-network language model trained on text data. Internally, the generative AI model uses an encoder-decoder or transformer-based architecture with multiple attention layers. Each layer computes attention weights over token embeddings using learned weight matrices, and the model uses a large number of parameters (e.g., hundreds of millions or more) optimized via gradient-based learning on a training dataset. During deployment in the present system, the model processes the prompt sentence token by token, computes contextual embeddings, and generates an output sequence representing response information.

The server configures API parameters such as maximum number of output tokens, temperature, and top-k or nucleus sampling thresholds to control the variability and length of the generated text. The server also requests structured conventions in the response via the output format instruction segment of the prompt, for example by including instructions such as “Return the output as a ranked list with explicit reasons” or “Use labels ‘Candidate 1’, ‘Candidate 2’, and ‘Candidate 3’.”

The server receives the output text from the generative AI model and parses it into recommendation information. A response parsing module detects structural markers (such as numbered lists, labels, or key phrases) and extracts candidate assignments, associated roles, referenced skills, and justification phrases. The server maps natural-language identifiers (e.g., “Employee A”) to internal identifiers (e.g., user_id) using a lookup table. The server then creates recommendation information objects, each including an association between a user and a work item or an association between an apparatus and a task type, along with a score derived from rank position and model confidence indications. The server stores these recommendations in the task information table and logs the corresponding prompt sentence and raw model output in the history information table.

In an embodiment, the server directly supports apparatus control. For example, when the generative AI model recommends assigning a welding task to a specific apparatus, the server creates a task record containing fields such as apparatus_id, task_type=welding, parameters ={current_limit, speed, path_profile_reference}, and time window. The server transmits this task record to a terminal connected to the apparatus. The terminal converts the parameters into low-level control messages via intermediary control software, which may publish command messages to specific topics or send commands over a fieldbus protocol. The apparatus executes the welding motion according to the specified parameters, and the terminal monitors execution status, including start time, completion time, and error codes, and returns execution status information to the server.

This integration of recommendation information and apparatus control is not a mere automation of human decision-making. The server maintains a closed data flow in which real-time apparatus state information and execution results are reintegrated into the context vector, influencing subsequent prompt generation and recommendation conditions. This leads to technical improvements such as reduced latency in reassigning tasks when an apparatus fails, improved utilization rates of apparatuses due to more accurate mapping between capabilities and tasks, and reduced error rates due to emotion-aware task assignment for users in safety-critical environments.

The server further implements a feedback-driven adaptation module. This module computes metrics from history information, such as acceptance rate of recommendations, mean task completion time, error frequency per task and per user, and resource utilization variability. The server uses these metrics to adjust prompt template selection and weighting rules. For example, the server may apply a reinforcement-learning-like update in which prompt features (e.g., inclusion of detailed emotion summaries) that correlate with high acceptance and low error rates are strengthened by increasing their selection probability. Conversely, features that correlate with low performance are weakened. This adaptation operates at the level of the prompt generation algorithm and the recommendation interpretation rules, rather than at a purely business-rule level, and directly affects how structured data are transformed into prompt sentences and back into task information. This results in an improvement of the computer system itself, as the server reduces the number of ineffective generative AI calls, decreases the need for post-processing corrections, and converges to more efficient patterns of computation and data access.

In another embodiment, the server employs an auxiliary neural network trained specifically to map context vectors to prompt configuration parameters. This auxiliary network receives as input the fused context vector and past performance features and outputs a compact set of prompt parameters, such as which template to use and which segments to include or emphasize. The network is trained using supervised learning, where target labels are derived from historical records of successful and unsuccessful prompts. The loss function includes terms reflecting both recommendation acceptance and execution quality. During training, the server computes gradients of the loss function with respect to the network weights and updates the weights using a stochastic gradient descent algorithm or a variant thereof. By learning a mapping from technical context features to prompt configuration, the system goes beyond simple rule-based logic and implements a non-conventional, data-driven method for controlling the behavior of the generative AI model in a way that improves system-level performance.

The terminal provides visualization and interaction functions that exploit the structure of task information. When the server sends task information and associated explanation text to the terminal, the terminal displays recommended assignments in a structured layout, such as a table showing users, assigned tasks, start and end times, and confidence scores, along with a pane showing the key reasons extracted from the model output. The user can accept individual recommendations, partially modify them (for example, shift start times or change priorities), or reject them. The terminal captures these actions as acceptance information and transmits them to the server. The server stores acceptance information in history information records and associates them with the originating prompt sentence and recommendation information using unique identifiers. This explicit linking enables subsequent analysis of which combinations of context features and prompt configurations yield the best outcomes. In one use case, the user requests identification of leaders for a new product line. The user enters a free-form instruction at the terminal, such as:

“I need a leader for a new robotics product line who has more than 5 years of experience and enjoys new challenges.”

The terminal sends this instruction to the server. The server analyzes the instruction sentence using a natural-language understanding module that extracts conditions such as minimum years of experience, required leadership skills, and preference for new challenges. The server translates these conditions into filter criteria for the database query and into constraint metadata for the context vector. The prompt generation module then composes a prompt sentence such as:

“We have an employee database with fields: department, years_of_experience, project_lead_experience, new_project_experience, preferences, and current emotion state. The manager is looking for a leader for a new robotics product line. Conditions: years_of_experience >=5, high project leadership capability, strong interest in new challenges, and current emotion state not fatigued. Based on these conditions and the database information, identify the top three candidate employees, rank them from 1 to 3, and explain your reasoning for each candidate.”

The generative AI model returns a response that the server interprets into recommendation information, for example listing three user_ids with associated scores and explanations. The terminal displays the result, and the user confirms or adjusts the final selection.

In another use case, the user focuses on apparatus assignment for a production line. The server periodically aggregates apparatus state information, including vibration statistics, throughput, and error counts, into context vectors. The prompt generation module constructs prompt sentences that explicitly contrast apparatus capabilities, such as:

“Given apparatus A with high welding accuracy and low error rate, and apparatus B with high inspection throughput but lower welding accuracy, and given upcoming tasks [welding of frame components, inspection of finished units], propose an optimal assignment of these tasks to apparatus A and apparatus B to maximize overall throughput while keeping error rates low.”

The generative AI model responds with an assignment plan that the server turns into machine-readable task records. The terminal converts these records into commands executed by the apparatuses, and the resulting throughput and error statistics feed back into history information.

Through these embodiments, the server, terminal, and user cooperate to implement the claimed system. The server executes non-conventional data fusion, prompt generation, and feedback-driven adaptation algorithms that transform diverse operational data into optimized prompt sentences for a generative AI model and convert the resulting text outputs into structured task information directly controlling or influencing apparatus behavior. This architecture improves computer technology itself by reducing redundant computations, decreasing communication load via feature compression, increasing the stability and accuracy of AI-assisted recommendations through adaptive prompt control, and enabling faster and more reliable coordination between recommendation logic and machine control, rather than merely automating a human decision process.

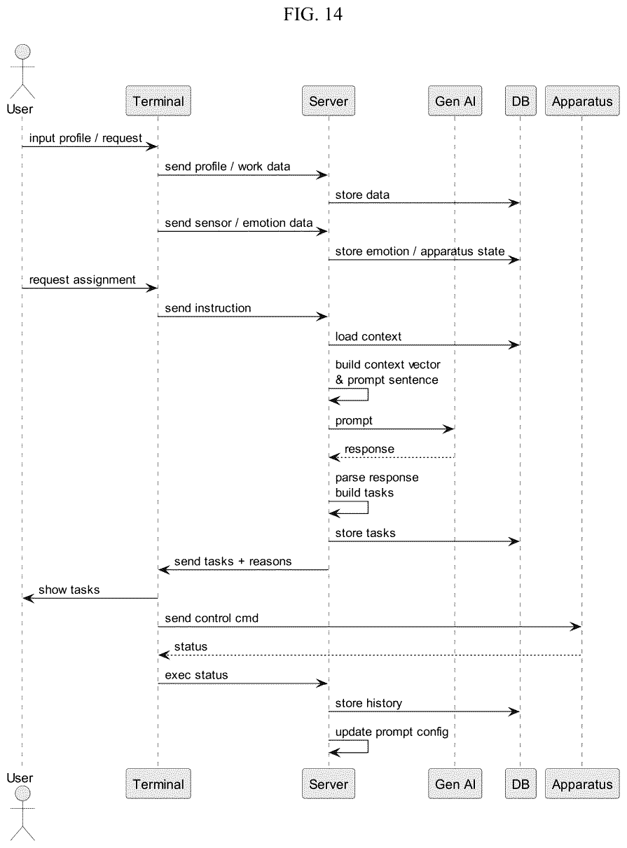

The following describes the processing flow using FIG. 14.

Step 1:

Server: The server receives work information and human-resource requirement information from the terminal as structured messages (input), validates field formats and required keys, and writes the validated records into corresponding tables in the database (output). The server parses each message, converts text fields into normalized codes and vectors, and executes SQL INSERT or UPDATE statements so that the work information becomes part of management information used in later processing.

Step 2:

Terminal: The terminal presents GUI forms to the user and receives user profile inputs such as experience information, performance information, preference information, and personality information (input). The terminal converts these inputs into a structured data object and transmits the object to the server via a network protocol (output). The terminal additionally associates the data with the current user identifier and session identifier before transmission.

Step 3:

Server: The server receives the user profile information from the terminal (input), validates numeric ranges and categorical values, and converts free-text entries into internal codes or feature vectors using look-up tables and encoding algorithms (processing). The server then stores the processed user profile information into user profile tables of the database (output), ensuring that each record is indexed by user identifier for efficient retrieval.

Step 4:

Terminal: The terminal activates an imaging device and an audio acquisition device when the user starts an interaction (input: raw image frames and audio samples). The terminal optionally performs preliminary feature extraction, such as computing facial landmarks and basic audio statistics, and packages the raw or preprocessed features into a compact payload (output). The terminal transmits this payload to the server for emotion analysis.

Step 5:

Server: The server receives visual and audio features from the terminal (input), feeds these features into an emotion classification module implemented as a neural network, and computes probabilities for predefined emotion categories (processing). The server selects the most probable emotion label or a weighted combination, associates the result with the user identifier and timestamp, and stores the emotion state information in an emotion information table of the database (output).

Step 6:

Terminal: The terminal connects to one or more apparatuses, such as robots or work machines, via intermediary control software (input: low-level sensor streams and status messages). The terminal aggregates sensor data over defined time windows to compute sensor_feature_vectors, including averages, maxima, minima, and frequency of error events (processing). The terminal then transmits these compact feature vectors to the server as apparatus state reports (output).

Step 7:

Server: The server receives apparatus state reports from the terminal (input), validates the integrity of the data, and stores each report into an apparatus state information table indexed by apparatus identifier and timestamp (output). The server may additionally compute derived features, such as health indices or capacity scores, by applying predefined formulas to the sensor_feature_vectors (processing).

Step 8:

Server: The server identifies a decision context, such as selecting a leader for a project or assigning a task to an apparatus, based on a request from the user or an internal trigger (input: context identifier and optional instruction sentence). The server retrieves relevant work information, human-resource requirement information, user profile information, emotion information, and apparatus state information from the database using SQL queries (processing). The server combines the retrieved records into structured data objects representing the current context (output).

Step 9:

Server: The server converts the structured data objects into numerical context vectors by concatenating feature vectors and standardizing them (input: structured data). The server may reduce dimensionality or compute similarity metrics, such as cosine similarity between user skills and work requirements, to quantify matching degrees (processing). The server outputs a fused context representation containing work_context_vector, user_context_vector, emotion_context_vector, and apparatus_context_vector (output).

Step 10:

Server: The server selects a prompt template and weighting configuration based on the fused context representation and historical performance metrics (input: context vectors and history information). The server applies rule-based or learned logic to determine which data elements to emphasize, such as giving higher weight to emotion information in safety-critical tasks (processing). The server outputs a template configuration indicating which segments and placeholders will be used for the prompt sentence (output).

Step 11:

Server: The server generates a natural-language prompt sentence by filling the selected template with data extracted from the structured context (input: template configuration and structured data). The server replaces placeholders with concrete values such as skill lists, years of experience, current emotion labels, and apparatus capabilities, and concatenates segments into a coherent text (processing). The server outputs a prompt sentence suitable for input to a generative AI model (output).

Step 12:

Server: The server transmits the generated prompt sentence to an external generative AI model via an API (input: prompt sentence and model parameters). The server includes configuration parameters such as maximum output length and sampling settings, sends the request, and waits for the response (processing). The server receives response information as a text sequence from the generative AI model (output).

Step 13:

Server: The server analyzes the text sequence returned by the generative AI model (input), detects structural patterns such as lists and labels, and extracts candidate recommendations, including proposed user-to-work assignments or task-to-apparatus assignments (processing). The server maps human-readable identifiers back to internal identifiers, calculates scores based on rank or explicit scores in the text, and constructs recommendation information objects (output).

Step 14:

Server: The server converts the recommendation information into task information formatted for internal storage and downstream consumption (input: recommendation information). The server creates database records that link user identifiers, work identifiers, apparatus identifiers, and scheduling parameters, and stores these records in a task information table (processing). The server simultaneously creates explanation text fields from the model's reasoning, associating them with the corresponding task records (output).

Step 15:

Server: The server sends the task information and associated explanations to the relevant terminal devices (input: selected task records). The server formats the data into structured messages, such as JSON, that include task parameters, identifiers, and human-readable descriptions (processing). The server transmits these messages over the network to the terminals (output).

Step 16:

Terminal: The terminal receives the task information and explanations from the server (input), parses the structured message, and updates its internal state to reflect new assignments (processing). The terminal displays the assignments to the user on the GUI, including details such as which user is assigned to which work, when the task should start, and why the assignment is recommended (output: visual presentation).

Step 17:

Terminal: In an apparatus-control scenario, the terminal selects task records targeting apparatuses (input: apparatus-related task information). The terminal maps high-level task parameters to low-level control parameters required by the intermediary control software, such as motion profiles or process settings (processing). The terminal sends corresponding control commands to the apparatus, initiating execution of the assigned task (output: apparatus control messages).

Step 18:

Terminal: The terminal monitors execution progress by receiving feedback from the apparatus via the intermediary control software (input: execution status messages and sensor updates). The terminal aggregates execution data, such as start and end times, error events, and performance metrics (processing). The terminal sends execution status information back to the server in a structured format (output).

Step 19:

Server: The server receives execution status information from the terminal (input), validates time stamps and identifiers, and stores the information in the history information table, linking it to the corresponding task records and originating prompt sentence (processing). The server outputs updated history information that reflects how recommendations were executed in the real environment (output).

Step 20:

User: The user reviews the assignments, explanations, and execution results displayed on the terminal (input: visual information). The user decides to accept, modify, or reject one or more recommendations based on domain knowledge and constraints (processing in human cognition). The user enters actions such as “accept,” “adjust schedule,” or “reassign” via the GUI (output: user commands).

Step 21:

Terminal: The terminal receives the user commands (input), encodes them as acceptance information indicating the user's response to each recommendation, and transmits this information to the server (output). The terminal may also update its local display to reflect the user's decisions.

Step 22:

Server: The server receives the acceptance information from the terminal (input), stores it as part of history information linked to the associated prompt sentences and recommendation records (processing). The server computes summary statistics such as acceptance rates and typical modification patterns, updating internal metrics used for adaptation (output: updated history and performance metrics).

Step 23:

Server: The server updates the configuration of the prompt generation module and recommendation interpretation rules based on the updated history information (input: performance metrics and historical records). The server adjusts template selection probabilities, segment weightings, and parsing thresholds so that future prompt sentences and interpretation logic emphasize information that historically led to better outcomes (processing). The server outputs new configuration parameters that will be applied in subsequent decision contexts (output).

Step 24:

Server: The server logs all key artifacts in the processing pipeline, including structured context data, prompt sentences, model responses, recommendation information, task information, execution status, and acceptance information (input: intermediate and final data objects). The server writes these artifacts to persistent storage with appropriate indexing and identifiers (processing). The server thereby outputs a complete trace of each decision cycle, enabling reproducibility, audit, and further model or rule refinement (output).

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

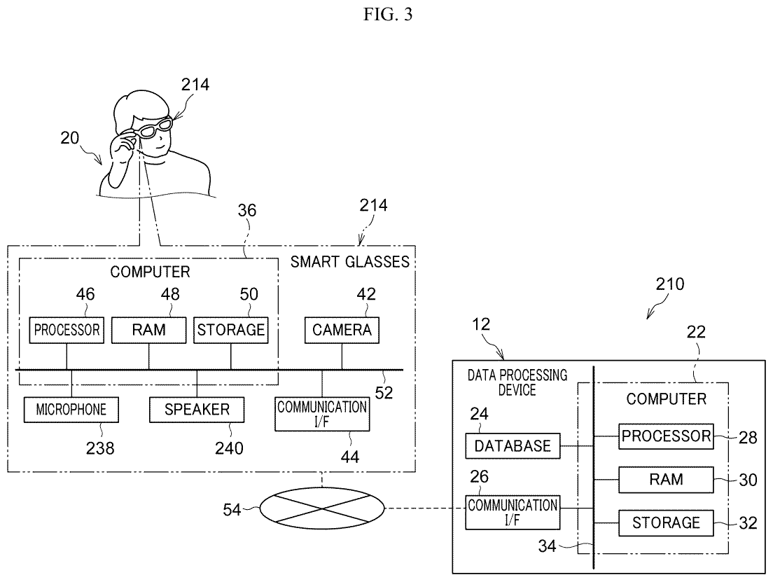

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

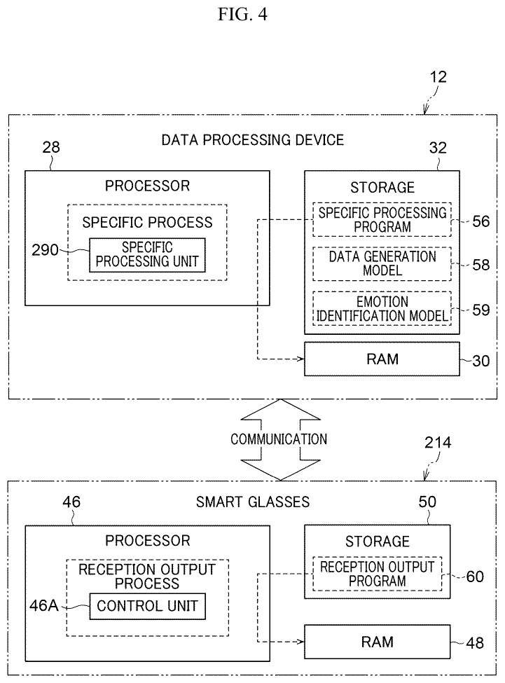

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

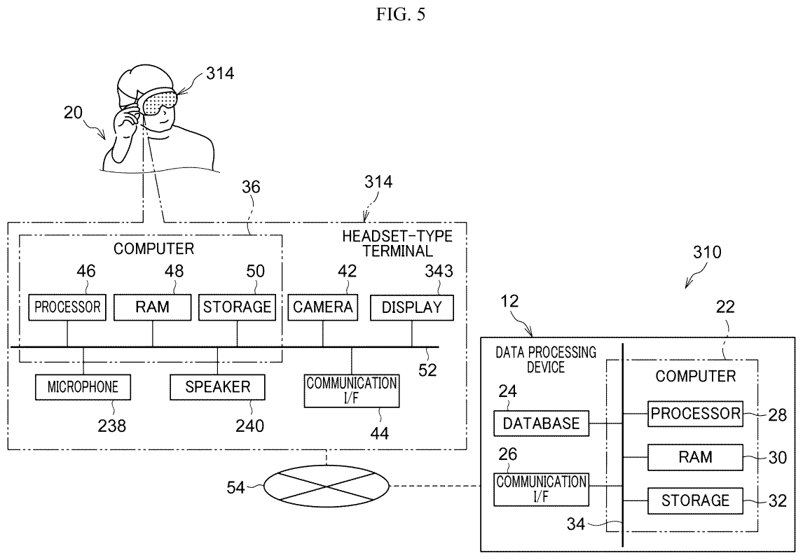

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

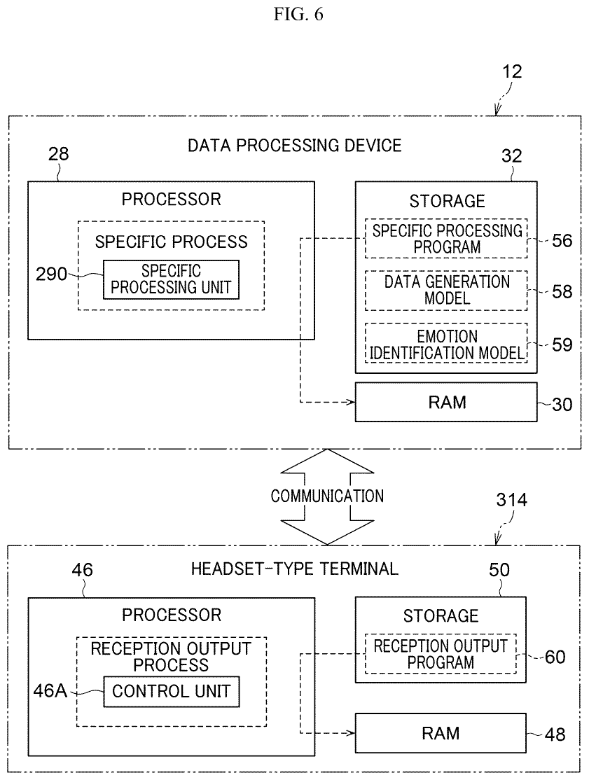

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

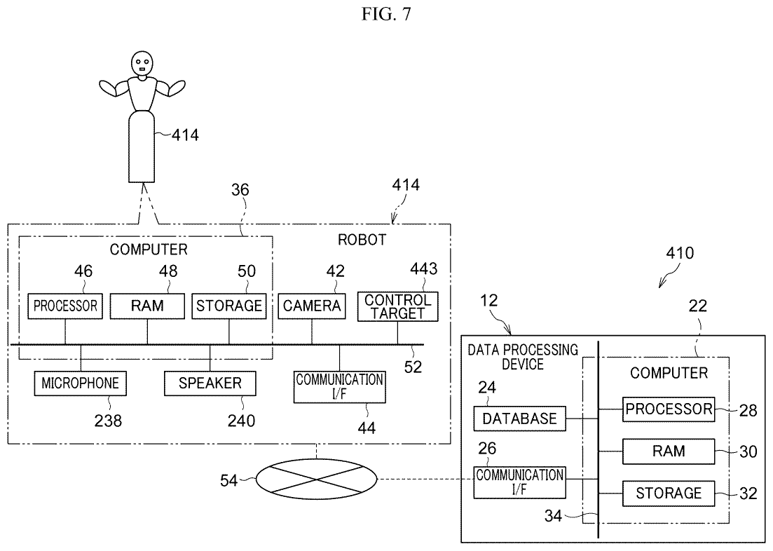

FIG. 7 illustrates an example of a configuration of a data processing system 410 according to a fourth exemplary embodiment.

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

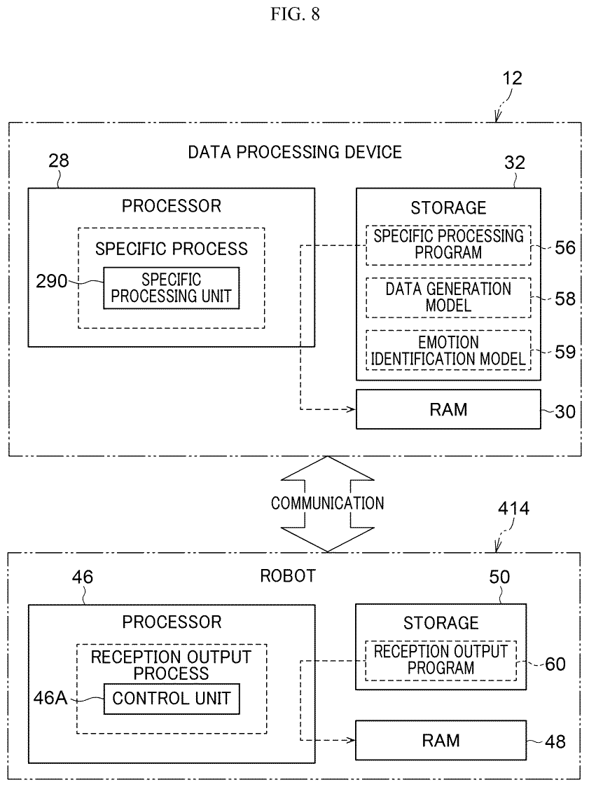

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

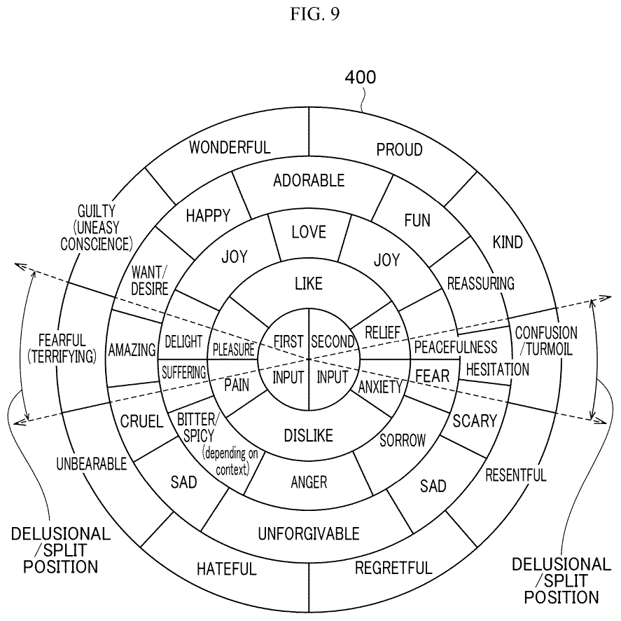

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

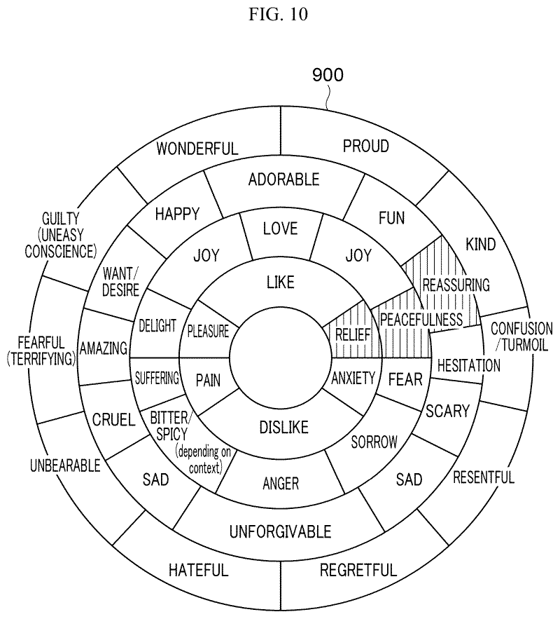

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to

receive, via an input/output interface, work-related information and human-resource-related information from a user,

convert the received work-related information and human-resource-related information into structured information, and transmit the structured information as a request based on a communication protocol,

receive the transmitted structured information and store the structured information as relational information in a storage resource of an information management apparatus, input, into a generative AI model, a prompt sentence including a natural-language instruction received via the input/output interface, analyze the prompt sentence, and convert condition information obtained from the generative AI model into search conditions, and

execute a search process on the relational information using a query language in accordance with the search conditions, and present a search result to the user via the input/output interface.

### (Supplementary 2)

The system according to supplementary 1,

wherein the processor is configured to

store, as the work-related information, work-classification information, store, as the human-resource-related information, skill information, qualification information, and experience information as separate information sets, and, based on the work-classification information, the skill information, the qualification information, and the experience information extracted from the prompt sentence and included in the search conditions, execute, on the relational information, the search process including a join process using the query language.

### (Supplementary 3)

The system according to supplementary 1,

wherein the processor is configured to

display, in a list format, the human-resource-related information obtained by the search process, and perform display control that enables the user to determine a human-resource allocation candidate by selecting, from the list format, each human resource.

### Application Example 1

### (Supplementary 1)

A system comprising a processor and a memory,

wherein the processor is configured to

store task information and personnel information as data structures in the memory, receive real-time personnel information including identification information, location information, and activity status information from an information acquisition device that reads personnel identification information, and update the personnel information stored in the memory based on the real-time personnel information,

convert the task information and the personnel information into feature vectors, and calculate suitability values between tasks and personnel by using a machine learning model executed by a numerical computation processing unit,

select candidate personnel for each task on the basis of the suitability values, and generate a prompt sentence for a generative AI model by constructing context information including attribute information of the candidate personnel and the suitability values,

transmit the prompt sentence to an external generative AI model via a communication interface and receive assignment proposal information generated by the generative AI model, generate structured data representing the assignment proposal information and provide, to a display device or a terminal device, candidate personnel assignments for the tasks and explanatory information corresponding to reasons for the candidate personnel assignments, and

receive, from a user, approval information or modification information for the candidate personnel assignments, store a result of the approval information or the modification information in the memory, and update at least one of parameters of the machine learning model and parameters of prompt sentence generation processing on the basis of the result.

### (Supplementary 2)

The system according to supplementary 1,

wherein the processor is configured to

receive, as the real-time personnel information, a code reading result and position information obtained by the information acquisition device installed at a work site, and repeatedly execute the calculation of the suitability values and the selection of the candidate personnel at predetermined time intervals or in response to a change in the personnel information, thereby continuously updating task-by-task personnel assignment proposals.

### (Supplementary 3)

The system according to supplementary 1,

wherein the processor is configured to

assemble the prompt sentence by describing, in a natural language, explanation information including task requirement conditions, personnel skill attributes, qualification attributes, experience attributes, preference attributes, and numerical suitability values output by the machine learning model, and obtain, from the generative AI model, the assignment proposal information including recommended personnel for each task and selection reasons corresponding to the recommended personnel.

### Example 2

### (Supplementary 1)

A system comprising a processor,

wherein the processor is configured to

acquire, from an information input/output device operated by a user, person information including experience information, achievement information, preference information, and personality information regarding a person, the person information being input together with job-related information, and convert the person information into structured information and transmit the structured information as a request message in accordance with a communication protocol, and

receive the request message, decode encrypted communication included in the request message, parse the structured information to extract the person information, convert the person information and the job-related information into registration commands for a relational information management device, and store the person information and the job-related information as an information set in the relational information management device, and acquire, from the information set, the person information and the job-related information, and generate evaluation target information corresponding to the person by combining the experience information, the achievement information, the preference information, and the personality information included in the person information with work content information, required capability information, qualification information, and experience value information included in the job-related information, and

format the evaluation target information into natural language, generate a prompt sentence including a problem description for presenting job candidates suitable for the person, and supply the prompt sentence as an input to a generative information processing model and execute the generative information processing model, and

acquire a response sentence output from the generative information processing model, the response sentence indicating one or more job candidates for the person and reasons therefor, convert the response sentence into display information, transmit the display information to the information input/output device, and cause the information input/output device to output a suitable job proposal for the person.

### (Supplementary 2)

The system according to supplementary 1,

wherein the processor is configured to

compare and analyze, for a plurality of items of person information and a plurality of items of job-related information stored in the information set, the experience information, the achievement information, the preference information, and the personality information with the work content information, the required capability information, the qualification information, and the experience value information, calculate, based on a result of the comparison, a suitability index for each person, and select, as a candidate of the evaluation target information to be input to the generative information processing model, job-related information whose suitability index satisfies a predetermined condition.

### (Supplementary 3)

The System According to Supplementary 1,

wherein the processor is configured to

acquire, in response to an instruction from the user regarding a change of assignment of the person, an application of the person for a job, or a job transfer of the person, the person information of a target person and job-related information selected based on the suitability index from the information set, generate, based on an acquisition result, a prompt sentence including at least one of an assignment policy, an application admissibility, and a transfer candidate, and execute the generative information processing model by using the prompt sentence so as to provide, to the information input/output device, suitable-person suitable-position information usable when the person changes assignment or applies for a job.

### Application Example 2

### (Supplementary 1)

A system comprising a processor, a storage device, and an interface device, wherein the processor is configured to

store, in the storage device, work information and human-resource requirement information as management information,

receive, via the interface device, input information including experience information, performance information, preference information, and personality information of a user, and store the input information in the storage device as user profile information,

obtain emotion state information of the user by supplying signals acquired from at least one of an imaging device and an audio acquisition device to an emotion analysis process, and store the emotion state information in the storage device as emotion information,

obtain detection information representing an operational state of an apparatus or a work machine, and store the detection information in the storage device as apparatus state information,

retrieve, from the storage device, at least a part of the work information, the human-resource requirement information, the user profile information, the emotion information, and the apparatus state information, and generate structured data by performing predetermined preprocessing on the retrieved information,

convert the structured data into a natural-language description, and generate a prompt sentence including the natural-language description as an input sentence for a generative AI model,

transmit the prompt sentence to an external generative AI model, acquire response information from the external generative AI model, and analyze the response information to generate recommendation information including at least one of placement candidate information, work assignment information, and apparatus assignment information, and structure the recommendation information as task information and generate output information for provision of the task information to at least one of a user terminal and a control target apparatus.

### (Supplementary 2)

The System According to Supplementary 1,

wherein the processor is configured to

transmit the task information included in the recommendation information to a terminal device,

cause the terminal device to control an apparatus via intermediary control software for a work machine on a basis of the task information,

receive execution status information of a work performed by the apparatus from the terminal device,

store the execution status information in the storage device as history information, and update at least one of a generation condition of the prompt sentence and a generation condition of the recommendation information on a basis of the history information for a subsequent generation process.

### (Supplementary 3)

The system according to supplementary 1,

wherein the processor is configured to

analyze an instruction sentence input by the user via the interface device, determine constituent elements and weighting of the prompt sentence on a basis of a content of the instruction sentence and the management information stored in the storage device, and adaptively change at least one of a template of the prompt sentence and a generation rule of the recommendation information by analyzing a correspondence between previously generated prompt sentences and acceptance information of the recommendation information provided by the user.

What is claimed is:

1. A system comprising:
circuitry configured to:
receive, via a communication interface coupled to a packet-switched network, first attribute data and second attribute data from a terminal device, and store the first attribute data and the second attribute data as relational information in a storage device, the relational information comprising a plurality of record sets associated by relational keys;
receive, via the communication interface, an instruction sentence from the terminal device, tokenize the instruction sentence into subword tokens, and convert the subword tokens into embedding vectors using an embedding table of a generative neural network model;
supply the embedding vectors as input to the generative neural network model to obtain condition information from output of the generative neural network model, the condition information comprising one or more predicates corresponding to attribute fields of the relational information; and
generate, based on the condition information, a query expression in a query language specifying join operations across the plurality of record sets, execute the query expression on the relational information to obtain a result set, and transmit the result set to the terminal device via the communication interface.

2. The system according to claim 1, wherein the circuitry is configured to normalize the first attribute data and the second attribute data into separate normalized record tables and maintain association tables that link records of the normalized record tables by foreign keys, such that the relational information supports multi-table join operations.

3. The system according to claim 2, wherein the circuitry is configured to build index structures on selected columns of the normalized record tables and use the index structures to accelerate execution of the join operations in the query expression.

4. The system according to claim 3, wherein the circuitry is configured to use cardinality statistics of the index structures to select an execution plan for the join operations, the execution plan specifying one of a nested-loop join algorithm, a hash join algorithm, or a merge join algorithm.

5. The system according to claim 4, wherein the first attribute data comprises classification label data and requirement parameter data stored as separate records in the relational information, and the second attribute data comprises capability data and credential data stored as separate records linked to identity records by the association tables.

6. The system according to claim 5, wherein the classification label data comprises work classification information, and the capability data and the credential data comprise skill information, qualification information, and experience information stored as separate information sets linked to personnel entity records by the association tables.

7. The system according to claim 1, wherein the circuitry is configured to encode the first attribute data and the second attribute data as numerical feature vectors by mapping categorical attribute values to positions of a fixed-dimension numeric array and normalizing numerical attribute values by subtracting a precomputed mean and dividing by a precomputed standard deviation.

8. The system according to claim 7, wherein the circuitry is configured to compute numerical suitability values between pairs of first attribute data records and second attribute data records by applying a machine learning model to the numerical feature vectors, the machine learning model comprising a feed-forward neural network with an output layer producing a scalar suitability score for each pair.

9. The system according to claim 8, wherein the circuitry is configured to filter pairs to those whose suitability values satisfy a threshold value, sort the filtered pairs by suitability value, and incorporate the suitability values of selected pairs into a prompt sentence supplied as input to the generative neural network model together with the instruction sentence.

10. The system according to claim 9, wherein the circuitry is configured to receive feedback data from the terminal device via the communication interface, the feedback data representing user acceptance or modification of candidate records in the result set, and update at least one of parameters of the machine learning model and parameters of a prompt sentence generation process based on the feedback data.

11. The system according to claim 1, wherein the circuitry is configured to generate evaluation target information by combining attribute fields of a record of the first attribute data with attribute fields of a plurality of records of the second attribute data whose suitability values satisfy a predetermined condition, and format the evaluation target information as a natural-language description for input to the generative neural network model as part of the instruction sentence.

12. The system according to claim 11, wherein the evaluation target information comprises experience information, achievement information, preference information, and personality information derived from the first attribute data combined with work content information, required capability information, qualification information, and experience value information derived from the second attribute data.

13. The system according to claim 12, wherein the circuitry is configured to receive a response sentence output from the generative neural network model indicating one or more candidate records and reasons therefor, convert the response sentence into display information, and transmit the display information to the terminal device, wherein the instruction sentence indicates at least one of an assignment change condition, a position application condition, or a transfer condition for the record of the first attribute data.

14. The system according to claim 1, wherein the circuitry is configured to receive visual signals from an imaging device and audio signals from an audio acquisition device, apply an emotion identification model to the visual signals and the audio signals to generate emotion state information representing an emotional condition of a user, and incorporate the emotion state information into structured data used to construct the instruction sentence supplied to the generative neural network model.

15. The system according to claim 14, wherein the circuitry is configured to receive detection information representing an operational state of an apparatus, store the detection information as apparatus state information in the storage device, incorporate the apparatus state information into the structured data, and generate task information based on recommendation information obtained from the generative neural network model for provision to at least one of the terminal device and a control target apparatus via the communication interface.

16. The system according to claim 1, wherein the circuitry is configured to analyze a correspondence between previously generated instruction sentences and acceptance information received from the terminal device, and adaptively adjust at least one of a template selection and a segment weighting of a prompt sentence generation process based on the correspondence, to update generation conditions for subsequent instruction sentences supplied to the generative neural network model.

17. The system according to claim 1, wherein the result set identifies matching records for at least one of a personnel placement, a task assignment, or an apparatus assignment, and the circuitry is configured to present the result set in a list format that enables a user to select one or more records as allocation candidates via the terminal device.

18. A system comprising:
circuitry configured to:
receive, via a communication interface coupled to a packet-switched network, work information and user profile information including experience information, achievement information, preference information, and personality information from a terminal device, and store the work information and the user profile information as management information in a storage device;
receive visual signals from an imaging device and audio signals from an audio acquisition device, apply an emotion identification model to the visual signals and the audio signals to generate emotion state information, and store the emotion state information in the storage device;
retrieve at least a part of the management information and the emotion state information from the storage device, compute numerical feature vectors from retrieved attributes of the work information and the user profile information, and calculate numerical suitability values between records of the work information and records of the user profile information by applying a machine learning model to the numerical feature vectors;
select candidate records of the work information whose numerical suitability values satisfy a threshold value, generate a prompt sentence incorporating the numerical suitability values and attribute information of the candidate records as a natural-language description, and transmit the prompt sentence to an external generative neural network model via the communication interface;
receive response information from the external generative neural network model, parse the response information to extract recommendation information comprising candidate associations and corresponding explanatory information; and
structure the recommendation information as task information and transmit the task information to at least one of the terminal device and a control target apparatus via the communication interface.

19. The system according to claim 18, wherein the circuitry is configured to receive execution status information from the terminal device, store the execution status information in the storage device as history information linked to the prompt sentence and the recommendation information, and update at least one of a generation condition of the prompt sentence and a generation condition of the recommendation information based on the history information.

20. A method comprising:
receiving, via a communication interface coupled to a packet-switched network, first attribute data and second attribute data from a terminal device, and storing the first attribute data and the second attribute data as relational information in a storage device, the relational information comprising a plurality of record sets associated by relational keys;
receiving, via the communication interface, an instruction sentence from the terminal device, tokenizing the instruction sentence into subword tokens, and converting the subword tokens into embedding vectors using an embedding table of a generative neural network model;
supplying the embedding vectors as input to the generative neural network model to obtain condition information from output of the generative neural network model, the condition information comprising one or more predicates corresponding to attribute fields of the relational information; and
generating, based on the condition information, a query expression in a query language specifying join operations across the plurality of record sets, executing the query expression on the relational information to obtain a result set, and transmitting the result set to the terminal device via the communication interface.
